(19) United States
(12) Patent Application Publication
(10) Pub. No.: US 2010/0033818 A1
(43) Pub. Date: Feb. 11, 2010

(54) MICROSTRUCTURES TO REDUCE THE APPEARANCE OF FINGERPRINTS ON SURFACES

(75) Inventors: Robert Petcavich, The Woodlands, TX (US); Daniel K. Van Ostrand, The Woodlands, TX (US); B. Tod Cox, Spring, TX (US)

Correspondence Address: FISH & RICHARDSON P.C., P.O. BOX 1022, MINNEAPOLIS, MN, 55440-1022, US

(73) Assignee: Uni-Pixel Displays,Inc., The Woodlands, TX (US)

(21) Appl. No.: 12/537,930

(22) Filed: Aug. 7, 2009

Related U.S. Application Data
(60) Provisional application No. 61/087,099, filed on Aug. 7, 2008.

(51) Int. Cl. G02B 1/10; B32B 3/30

(52) U.S. Cl. 359/507; 428/172

(57) ABSTRACT

Various shapes of microstructures and patterns of microstructures are provided to reduce the visibility of fingerprints, or other foreign marks, that occur on the surface of substrates due to handling. The microstructures may be formed directly on an exterior surface of a substrate to render the substrate fingerprint resistant, or formed on a surface of a polymeric sheet to provide a fingerprint-resistant protective layer that may be disposed onto a surface of a substrate (e.g., an optical display). The size, shape, orientation, and distribution of the microstructures across the surface of the substrate, or protective layer, may be optimized to enhance the durability of the microstructures and/or to impart a diffusing surface to the substrate for the particular application of the substrate. In some embodiments, the density and distribution of the microstructures on a transparent protective layer are also optimized in order to minimize the appearance of haze and Moiré when the protective layer is disposed on a surface of an optical display or other image producing surface.

### CROSS-REFERENCE TO RELATED APPLICATIONS

This application claims priority to U.S. Provisional Application Ser. No. 61/087,099 filed on Aug. 7, 2008, the entire contents of which are herein incorporated by reference.

### TECHNICAL FIELD

The present invention relates generally to the field of providing surfaces with microstructures to reduce the appearance of fingerprints due to handling contamination. More specifically, the present invention relates to providing various shapes and distributions of microstructures that reduce the visibility of fingerprints and exhibit superior durability to withstand shear forces encountered during handling.

### BACKGROUND INFORMATION

Fingerprints and other marks on a surface of a transparent substrate can optically distort the transmissive property of the surface such that light traversing the substrate (e.g., an image emitted from a display) is distorted. Likewise, on a non-transparent substrate surface, fingerprints and other marks/contaminants can optically distort the reflective property of the surface. The appearance or smudge of a fingerprint is a result of fingerprint oils transferred to the handled or contacted surface. The fingerprint is visible because the deposited oil lies unaffected on the contacted surface. Optical distortion due to fingerprints deposited on surfaces is particularly evident in a wide variety of devices normally held or handled by an operator. For example, fingerprints commonly appear on the external surfaces of substrates utilized as display screens of cellular phones, touch panels of interactive devices, household appliances (e.g., refrigerator door, stove range, etc.), and windows, to name a few. An effective solution to this problem would disperse and hide the deposited fingerprint oil such that the oil is no longer visible by the human eye of an operator (i.e., viewer).

One conventional solution is to clean the substrate surface with a cleaning solvent and/or a wipe (e.g., a towel). However, this solution is not convenient or practical for many applications due to the undesirable high frequency of cleaning and/or wipes are not readily available. Another solution is to treat flat surfaces to attract or repel oils with oleophilic or oleophobic surface coatings, but treatments do not sufficiently affect the deposited oil because the fingerprint oil is still visible on the treated surface. For example, in the field of touch display screens, there are several existing, but ineffective approaches for dealing with the fingerprint smudging problem. One approach is to apply a coating onto the display surface. Such coatings are often oleophobic coatings, which provide easy cleaning, but do not hide the fingerprint smudges. Another problem with such an approach is that the coating tends to wear off with extended use. Furthermore, coatings do not provide scratch protection for the display surface.

Another solution is to apply a transparent cover film over the surface of the touch display screen. Such a cover film does protect the display surface from scratches, but does not hide fingerprints. One such cover film utilized is a flat film. However, flat films do not hide fingerprints such that the deposited fingerprint oil is imperceptible by a human eye. An example of a flat film (“Invisi-Shield”, commercially available from Zagg, Inc.) is discussed hereafter with reference to FIGS. 27 and 28. If the flat film is surface treated with an oleophilic coating, this merely smears the fingerprints leaving the fingerprint oil still visible and renders an underlying image viewed through the film blurry. The reason is that the oleophilic (“oil loving”) surface is not effectively fingerprint resistant, but merely disperses the fingerprint oil but not the water and other components associated with a fingerprint smudge. The result is that such smudges and other contaminations are still visible. If the flat film uses an oleophobic coating, it tends to bead the fingerprint oils while leaving the fingerprint oil still clearly visible. The fluorochemical surface treatment utilized to make the surface oleophobic is intended to provide a mechanism that creates a high liquid contact angle, and therefore allegedly fingerprint resistant. The reality is that such a surface is easier to clean, but it is not fingerprint resistant because the fingerprint oil is still visible. Moreover, the index of refraction of such coatings can provide a mismatch with the refractive index of the cover glass/plastic such that the coatings actually highlight the fingerprint smudges. Also, fluorinated polymers are expensive to apply. Furthermore, oleophilic and oleophobic coatings tend to wear off with use, and cannot be applied in an aftermarket situation. Another utilized cover film is a matte finish film. However, this film does not adequately hide fingerprints, and its matte finish reduces optical performance by introducing a diffusive surface that diminishes the optical image transmitted through the film from the underlying display while also increasing the reflected haze from the surface. An example of a matte film (“anti-glare film” commercially available from Power Support) is discussed hereafter with reference with FIGS. 25 and 26. The strategy with the application of a matte finish film is to provide a roughened surface (e.g., a peak to valley or Rₜ=5.7 microns) by adding opaque micron-sized fillers to hide the fingerprints. However, such films demonstrate poor fingerprint resistance and, furthermore, the opaque fillers introduce haze to the film that undesirably scatters both transmitted and reflected light reducing the visibility of an underlying image viewed through the film.

The problem of optical distortion caused by fingerprints deposited on the surfaces of substrates has not been adequately solved and continues to be a problem for a wide variety of substrates comprising glass, plastic, or metal.

### BRIEF DESCRIPTION OF THE DRAWINGS

FIG. 1 is a cross-sectional schematic of a substrate section having a plurality of microstructures distributed on a top surface of the substrate in accordance with embodiments of the present invention;

FIG. 2 is a cross-sectional schematic of a substrate section having a plurality of microstructures distributed on a top surface of a protective layer (protective sheet/film) disposed onto a surface of the substrate in accordance with embodiments of the present invention;

FIGS. 3A-3F illustrate several geometries of exemplary microstructures in accordance with embodiments of the present invention;

FIG. 4A is a top view schematic of a substrate section having a plurality of cylindrical microstructures distributed on a top surface of the substrate in accordance with embodiments of the present invention;

FIG. 4B is a cross-sectional schematic of the substrate section illustrated in FIG. 4A;

FIG. 5 is a top view schematic of a substrate section having a plurality of pyramidal frustum microstructures distributed with a single orientation in accordance with embodiments of the present invention;

FIG. 6 is a top view schematic of a substrate section having a plurality of pyramidal frustum microstructures distributed with a substantially random orientation in accordance with embodiments of the present invention;

FIG. 7A is a top view schematic of a substrate section having a plurality of elongated linear microstructures distributed with different orientations in a plurality of patterns in accordance with embodiments of the present invention;

FIG. 7B is a perspective view of one pattern of microstructures depicted in FIG. 7A;

FIG. 8 is a top view schematic of a substrate section having a plurality of elongated linear microstructures distributed with different orientations within several different patterns in accordance with embodiments of the present invention;

FIG. 9 is a top view schematic of a substrate section having a plurality of elongated linear microstructures distributed with different orientations in a linear starburst pattern in accordance with embodiments of the present invention;

FIG. 10 is a top view schematic of a substrate section having a plurality of elongated curved microstructures distributed with different orientations in a curved starburst pattern in accordance with embodiments of the present invention;

FIG. 11 is a top view schematic of a substrate section having a plurality of elongated curved microstructures distributed with different orientations in another curved starburst pattern in accordance with embodiments of the present invention;

FIG. 12 is a top view schematic of a substrate section having a plurality of elongated curved microstructures distributed with different orientations, sizes and spacing in another curved starburst pattern in accordance with embodiments of the present invention;

FIG. 13 is a top view schematic of a substrate section having a plurality of elongated curved microstructures distributed with a concentric orientation in a concentric broken rings pattern in accordance with embodiments of the present invention;

FIG. 14 is a top view schematic of a substrate section having a plurality of elongated curved microstructures distributed with a concentric orientation in another concentric broken rings pattern in accordance with embodiments of the present invention;

FIG. 15 is a top view schematic of a substrate section having a plurality of elongated curved microstructures in a concentric rings pattern with a hexagonally close-packed distribution in accordance with embodiments of the present invention;

FIG. 16 is a top view schematic of a substrate section having a plurality of elongated curved microstructures distributed in different orientations with a chromosome pattern wherein the microstructures have a single length and rectangular-shaped ends;

FIG. 17 is a top view schematic of a substrate section having a plurality of elongated curved microstructures distributed in different orientations with a hot-dog pattern, wherein the microstructures have two different lengths (bimodal population) and rounded-shaped ends;

FIG. 18A is a SEM micrograph of a bimodal population of hot-dog shaped elongated microstructures formed on a protective layer, in accordance with embodiments of the present invention;

FIG. 18B is an enlarged view of a section of the SEM micrograph shown in FIG. 18A;

FIG. 19 is a SEM micrograph of a single population of hot-dog shaped elongated microstructures formed on a protective layer in accordance with embodiments of the present invention;

FIG. 20 is a SEM micrograph of recessed elongated curved microstructures formed on a protective layer in accordance with embodiments of the present invention;

FIG. 21 illustrates an example system for manufacturing a substrate having a plurality of microstructures distributed on a top surface of the substrate;

FIG. 22 is a table comparing fingerprint resistance and other attributes of the present invention to the prior art;

FIG. 23 shows an example of fingerprint resistance exhibited by a substrate having a plurality of microstructures in accordance with embodiments of the present invention;

FIG. 24 shows a comparison example of fingerprint resistance exhibited by another embodiment of a substrate having a plurality of microstructures wherein the microstructure density is less than in FIG. 23;

FIG. 25 shows a digital image from a microscope of a prior art surface film having a substantially matte finish;

FIG. 26 shows the fingerprint resistance provided by the prior art surface film having a substantially matte finish;

FIG. 27 shows a digital image from a microscope of another prior art surface film having a substantially smooth surface;

FIG. 28 shows an example of the fingerprint resistance provided by the prior art surface film having a substantially smooth surface;

FIG. 29 shows two tables of luminance data measured for an optical display with and without a fingerprint resistant film of the present invention disposed thereon; and

FIG. 30 is an exemplary plot of haze as a function of microstructure density for a given microstructure height.

### DETAILED DESCRIPTION

One or more embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

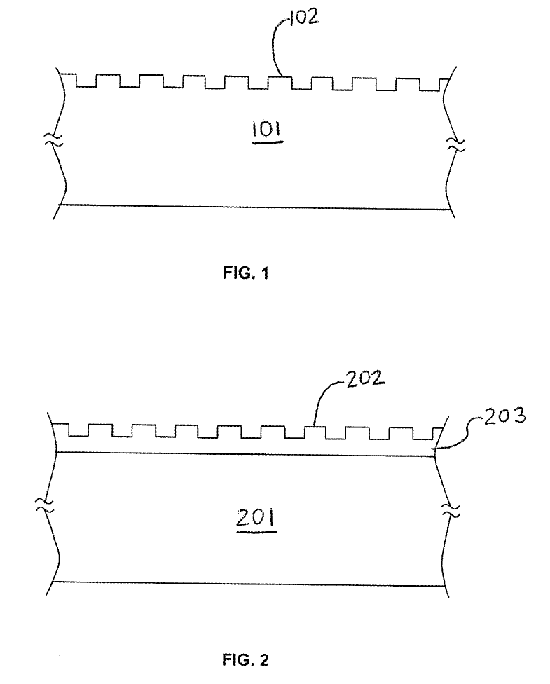

The various embodiments of the present invention provide a plurality of microstructures on a surface of a substrate to reduce the visibility of fingerprint oils and other contaminants typically deposited onto the surface during handling. In one embodiment, a plurality of microstructures 102 are formed directly on a surface of a substrate 101, as illustrated in FIG. 1, in order to provide fingerprint resistance to the substrate surface, such as the exterior surface of an optical display, the top surface of a stove range, or exterior surface of a refrigerator door. The plurality of microstructures 102 refer to the raised portions of the substrate surface. The substrate surface comprising the plurality of microstructures may be an external surface of the substrate 101 normally exposed to handling. In another embodiment, the microstructures 202 may be formed on a first surface of a substrate comprising a transparent or translucent glass or polymeric sheet (or film) to provide a fingerprint-resistant protective layer 203. The transparent or translucent fingerprint-resistant protective layer 203, hereinafter referred to as a “protective layer,” may be disposed onto a surface of another substrate 201, as illustrated in FIG. 2, by positioning a second surface (i.e., a relatively smooth and flat side) of the protective layer 203 onto the surface of the other substrate 201. The protective layer 203 may advantageously be disposed or positioned upon a surface of essentially any substrate (e.g., transparent glass or polymer, or a nontransparent material) to effectively render the surface fingerprint resistant. In some embodiments, the microstructures may be covered by a conformal hard coating to provide enhanced scratch resistance.

Embodiments of the present invention provide a variety of microstructure shapes and distributions (e.g., patterns) of microstructures on a surface of a substrate in order to provide a fingerprint resistant surface that may be optimized in terms of anticipated use and/or requisite durability (anticipated shear force exposure) for a particular application of the substrate. In some embodiments, the exterior surface of the substrate or protective layer may have a surface energy in the range from about 25 to about 35 dynes/cm² to enhance the spreading of deposited fingerprint oils. Furthermore, in some embodiments the density and distribution of microstructures on a protective layer are also optimized in order to minimize the appearance of haze and Moiré when the protective layer is disposed on a surface of an optical display or other image producing surface.

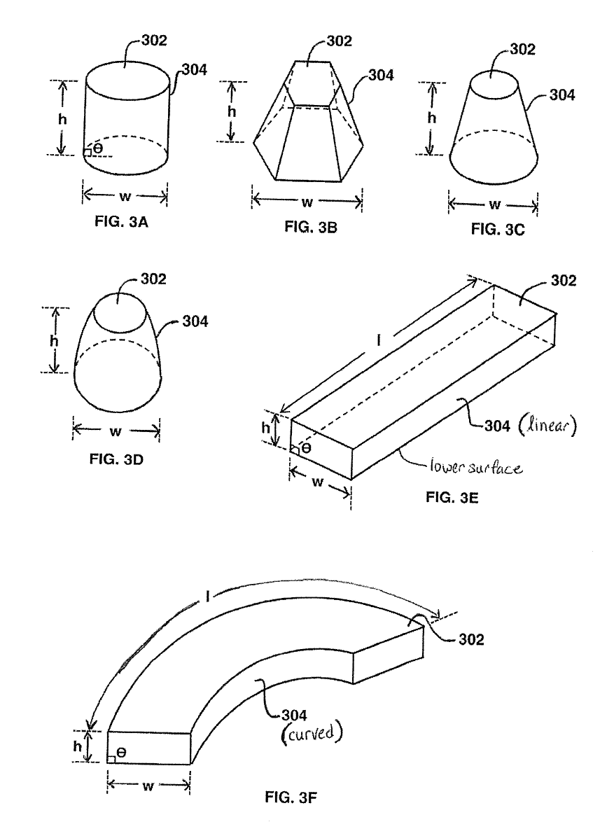

A microstructure may have essentially any geometry having a generally flat upper surface 302. Referring to FIGS. 3A-3F, examples of suitable microstructure geometries include cylindrical (FIG. 3A), pyramidal frustum (FIG. 3B), conical frustum (FIG. 3C), compound parabolic (FIG. 3D), compound elliptical, polyobject or any conic section revolved to form a solid. The pyramidal frustum geometry includes sidewall surfaces 304 that are generally flat surfaces, for example six flat sidewall surfaces as depicted in FIG. 3B, adjacent one another and around a circumference of the microstructure. It should be noted that the pyramidal frustum is not limited to any particular number of flat sidewall surfaces and other geometries may be used, for example, a pyramidal frustum having three flat sidewall surfaces with a triangular-shaped flat upper surface or four flat sidewall surfaces and a square-shaped flat upper surface as illustrated in FIGS. 5 and 6. In addition, a microstructure may have any desired elongated strip shape having a generally flat upper surface 302 and either linear or curved sidewalls; such a microstructure hereinafter is referred to as an “elongated microstructure.” Examples of elongated microstructure shapes include “rectangular” wherein the sidewalls 304 are straight or linear (FIG. 3E) and “curved-rectangular” wherein the sidewalls 304 are curved such that the microstructure's length (l) dimension is curved (FIG. 3F). The elongated strip shape is defined herein as a microstructure having a length (l) dimension greater than its width (w) dimension. Thus, the flat upper surface 302 of each of the various microstructures may have essentially any linear or curved shape, for example, polygon geometries such as a circular surface as depicted in FIGS. 3A, 3C, and 3D, a hexagonally-shaped surface as depicted in FIG. 3B, a rectangular surface as depicted in FIG. 3E, and a curved surface as illustrated in FIG. 3F. Furthermore, the flat upper surface 302 may be parallel to a lower surface of the microstructure and the plane of the substrate or protective layer. Although such microstructures may not be visible to the naked eye, the microstructures can be examined with a microscope to determine if surface microstructures are present.

The microstructure may have vertical sidewalls 304 wherein its height (h) dimension is generally perpendicular to its width (w) dimension (i.e., Θ is equal to about 90 degrees) as illustrated in FIGS. 3A, 3E and 3F. Alternatively, the microstructures may have non-vertical sidewalls 304 (non-vertical with respect to its width dimension and plane of the film) as illustrated in FIGS. 3B, 3C, and 3D. The non-vertical sidewalls provide a diffusive surface that causes light scattering of both transmitted light that may traverse the microstructure and ambient light that may reflect off the sidewall surface(s) of the microstructure. Thus, microstructures having vertical sidewalls may be employed to provide fingerprint resistance to a substrate or protective layer when no optical distortion of light is desired. Whereas, microstructures having non-vertical sidewalls may be employed to provide fingerprint resistance to a substrate or protective layer when a matte or diffusive surface is desired.

The microstructures have a height (h) in the range from about 1 micron to about 25 microns, and more preferably in a range from about 3 microns to about 10 microns. The height of the microstructure may be optimized in accordance with the particular application in terms of the anticipated particular contaminant and amount of the particular contaminant. For example, a fingerprint pressed onto a smooth surface normally leaves an oil mark in the range of 3 to 6 microns thick (i.e., a fingerprint having a height of 3 to 6 microns). To effectively break up and redistribute the oil while minimizing image distortion due to the fingerprint, a suitable array of microstructures may be fabricated on a surface of a substrate to provide a surface topology (peak to valley measurement or Rₜ) in the a similar range of about 3 to 10 microns.

In another aspect, microstructure geometry may be optimized to have the requisite shear strength. For example, in touch-screen display applications, the plurality of microstructures on the touch screen (i.e., substrate), or on a protective layer disposed over the touch screen, are subjected to finger contact or rubbing action due to the interaction of an operator with the touch screen. The finger contact and rubbing action that occurs on the upper surfaces of a plurality of microstructures during handling can result in the application of external shear forces that exceed the shear strength of one or more of the microstructures thereby causing the one or more microstructures to break and rub off the substrate. To increase microstructure shear strength and durability, the various microstructure geometries may have a low profile wherein the microstructure's width is equal to or greater than its height. As such, the microstructure dimensions have an aspect ratio of width to height (i.e., w:h) in a range from about 1 to about 13 (i.e., 1:1 to 13:1), and more preferably in a range from about 2 to about 10. For microstructures having variable width (i.e., a width that varies as a function of height, as depicted in FIGS. 3B, 3C and 3D), the width referred to in the determination of aspect ratio is the maximum width of the microstructure (i.e., the width of the lower surface).

In addition to a low profile, the elongated attribute of elongated microstructures (FIGS. 3E and 3F), wherein l is greater than w, further enhances microstructure durability during handling. As compared to the contact areas (i.e., l×w) of microstructures having essentially equal length and width dimensions (e.g., microstructures shown in FIGS. 3A-3D), the elongated microstructure (wherein l>w) exhibits enhanced durability due to an increase in contact area (l×w) to the substrate or protective layer upon which the microstructure is formed and connected. Increasing the contact area of an individual elongated microstructure advantageously increases its shear strength, thus enabling the elongated microstructure to withstand the application of higher shear forces that may occur during handling. A suitable length for each of the elongated microstructures may be in a range from about 10 to about 250 microns, more preferably in the range from about 35 microns to about 100 microns.

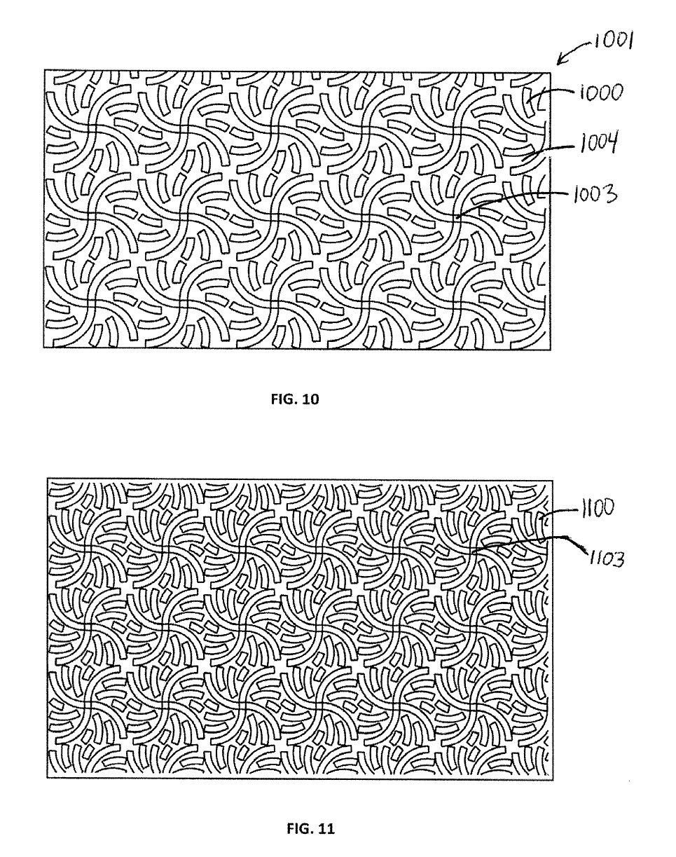

Furthermore, the curved orientation of the curved elongated microstructure (FIG. 3F), illustrated in FIGS. 10-20, even further enhances durability by introducing a varying orientation of a single microstructure such that an applied shear force (encountered during handling) is necessarily distributed along both width and length dimensions of the microstructure due to its curvature. Because of the relatively small (microscopic) sizes of the microstructures, it is presumed that when a finger slides across the upper flat surfaces of a plurality of microstructures, the finger slides in one direction (e.g., a straight line) with respect to any one of the microstructures thus applying a shear force in a single direction. Due to the relative physical dimensions of the elongated microstructures (wherein l is greater than w), an elongated microstructure has its greatest strength along its length dimension and its weakest strength across its width dimension. Thus, a shear force across a microstructure's width is the most likely point of material failure wherein the microstructure may break or rub off the substrate. Such failure may occur for a sufficiently high shear force applied to the sidewall along its width dimension (e.g., a shear force applied to the normal of its sidewall) of an elongated linear microstructure (e.g., FIGS. 3E, 7-9). Whereas, the same shear force applied to the sidewall (i.e., curved sidewall) of a curved elongated microstructure necessarily results in a distribution of the shear force over both the width and length dimensions of the curved microstructure (e.g., FIGS. 3F, 10-20), which increases the shear strength required to cause materials failure of the curved elongated microstructure. Thus, curved elongated microstructures, for example as illustrated in FIGS. 10-20, are particularly durable to withstand rubbing shear forces due to handling. Providing the microstructure with one or more attributes of a low profile, an elongated length dimension (l>w), and the curved orientation of the curved elongated length dimension is particularly beneficial in enhancing the shear strength of microstructures made of relatively low mechanical strength materials such as polymeric materials (e.g., PET, acrylates, etc.).

The substrate may comprise essentially any material that may be processed to form a plurality of microstructures (e.g., cylindrical, pyramidal frustum, rectangular or curved elongated microstructure) in a surface of the substrate or protective layer. Suitable substrate materials include glass, metal, and polymer. The plurality of microstructures may be formed into or onto a surface of a substrate by any known processing technique. For example, a planar surface of a glass substrate may be patterned and etched to remove glass material such that a plurality of microstructures are formed and remain on the surface of the substrate. In another example, a surface of a metal substrate (e.g., a metal sheet) may be etched, embossed, or stamped to form microstructures on the surface of the substrate. In yet another example, a polymerizable material on a substrate may be molded, cured by actinic radiation, thermally formed, embossed, ablated, etched, or any of a number of polymer processing techniques to form the microstructures on the surface of the substrate. Likewise, a polymerizable protective layer (e.g., polymeric sheet or film) may be molded, cured by actinic radiation, thermally formed, embossed, etched, or any of a number of polymer processing techniques to form the microstructures on a surface of the protective layer.

Thus, the plurality of microstructures formed in or on a surface of a substrate may comprise the same material as the substrate itself. In other words, the plurality of microstructures formed on a transparent or translucent substrate (e.g., optically clear glass or plastic substrate or optically clear polymeric protective layer) may be transparent/translucent microstructures that maintain a transmissive property of the substrate surface. Similarly, the plurality of microstructures formed on a nontransparent substrate (e.g., opaque plastic, glass, or metal substrate) may be opaque microstructures that maintain a reflective property of the substrate surface.

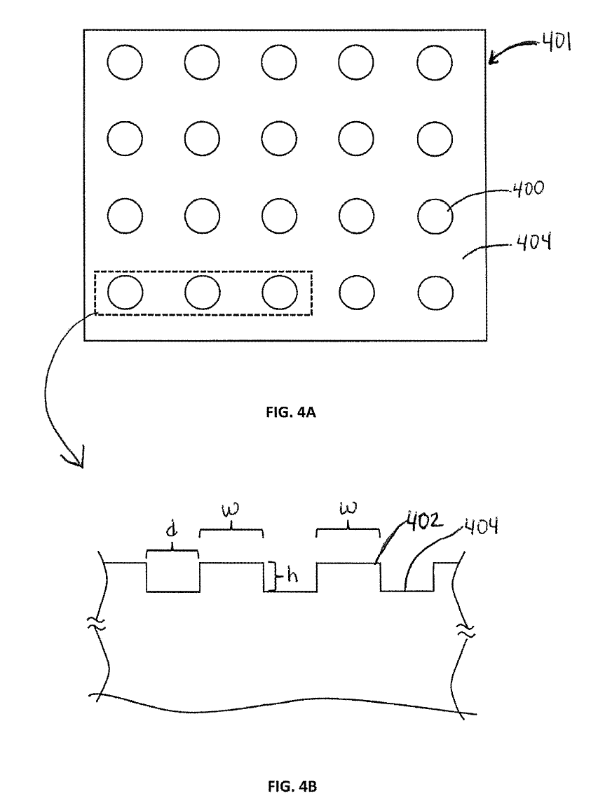

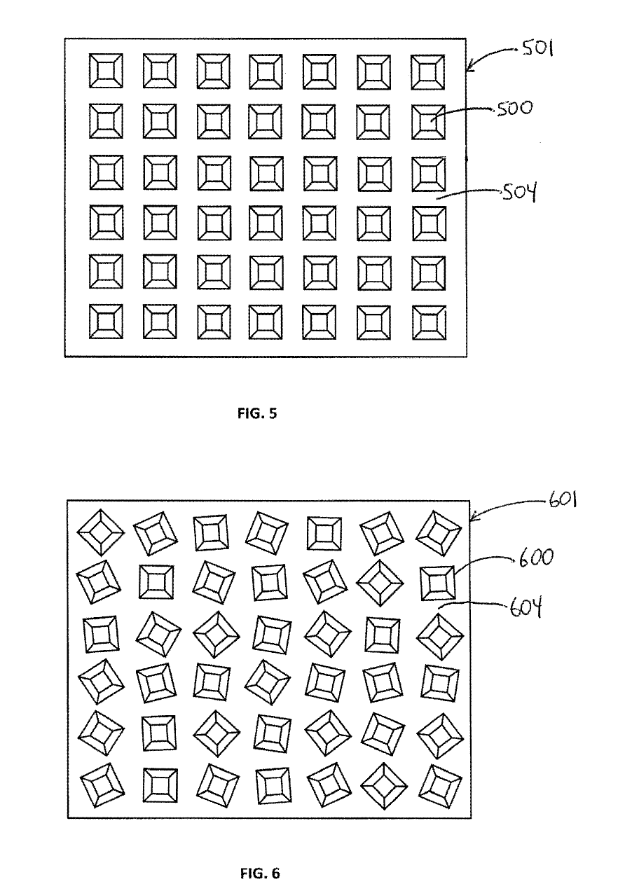

The microstructures 400 reduce image distortion due to foreign marks or contaminant substances, such as oils from fingerprints, typically deposited onto the surface of a substrate 401 during normal handling of the substrate 401, as depicted in FIGS. 4A and 4B. The generally flat upper surface 402 of the microstructure 400 is the distal end of the microstructure that faces an operator/user, and that a user would touch. The plurality of microstructures 400 reduces light distortion (transmissive or reflective) and visibility of the foreign mark substance by breaking up and redistributing the foreign mark substance deposited onto the flat upper surfaces 402 of the microstructures to other areas of the substrate. Specifically, the spaced-apart relationship of the individual microstructures 400 provides a surface topography that breaks up the foreign mark and promotes or allows for the redistribution of the foreign mark substance via capillary action. The surface topography comprises a plurality of microstructures 400 surrounded by an interstitial recessed area(s) 404 (also referred to as “valleys” or “channels”) between adjacent microstructures that accommodates the foreign mark substance that migrates to said area(s). The presence and proximity of adjacent microstructures causes capillary redistribution of the foreign mark to the recessed area(s). The recessed area 404 may be continuous (or contiguous recessed_areas), as depicted in FIG. 4A, and sufficiently sized (i.e., recessed surface area) so as to accommodate the foreign mark substance that migrates to the recessed area 404. The redistribution of the mark substance leaves relatively little foreign mark substance on the flat upper surfaces 402 of the microstructures, where the foreign mark was originally deposited, and thus permits light transmitted through (or reflected from) both the flat upper surfaces 402 and the recessed area 404 to reach the operator viewing the substrate 401 with less distortion. A single continuous recessed area 404 (as depicted in FIG. 4A) advantageously permits redistribution of the foreign mark across the entire recessed surface area, which minimizes the accumulation of foreign material sufficient to cause optical distortion. Furthermore, a single contiguous recessed area 404 can accommodate a larger quantity of foreign material. In one example, oil from a fingerprint deposited onto the flat upper surfaces 402 of a plurality of microstructures (e.g., as illustrated in FIGS. 4A, 5, 6, 7A, 8-18 described below) migrates to the recessed area 404 between the microstructures thereby decreasing the amount of fingerprint oil that remains on the flat upper surfaces 402 upon which the fingerprint was originally deposited. Reducing the amount of fingerprint oil on the flat upper surfaces 402 of the microstructures and spreading the oil throughout the recessed area 404 reduces the distortion of light traversing or reflecting off the surface of the substrate, thereby minimizing the visibility of the fingerprint.

Furthermore, the microstructures preferably have a width in a range from about 2 to 120 microns, and more preferably in a range from about 10 to 50 microns. Although a plurality of microstructures having widths less than about 2 microns exhibit fingerprint resistance, the individual microstructure is generally not sufficiently durable to withstand the shear forces due to a finger sliding on the flat upper surfaces of a plurality of microstructures during interactive contact of an operator. At widths greater than about 120 microns, the fingerprint oils deposited onto the flat upper surfaces of a plurality of microstructures tend to take too long to migrate to the recessed areas of the substrate. In other words, in the context of redistributing a fingerprint substance deposited onto the flat upper surfaces of microstructures having widths in excess of about 120 microns, the capillary action between adjacent microstructures deteriorates such that the deposited fingerprint is not sufficiently wicked away to the recessed area. A width range of 10 to 50 microns is more preferable because for most substrate materials microstructure widths greater than about 10 microns provide sufficient durability to withstand shear forces due to finger contact (rubbing), and microstructures widths less than about 50 microns are not detectable or noticeable by the human eye which may be preferred when it is desired that the microstructure surface features be unnoticeable by the viewer.

Referring to FIG. 22, there is shown a table comparing benefits and advantages of the microstructure substrate or protective layer of the present invention to the prior art techniques described above in the Background Information section. As can be readily seen, in addition to providing fingerprint resistance and good optical performance, embodiments of the present invention also provide several other significant benefits and advantages over the prior art techniques.

The aforementioned migration of the oils, also referred to as “wetting” or “spreading,” may be further enhanced by modifying the surface energy of the substrate (or protective layer). Because wetting of a substance generally occurs more readily over a surface having a higher surface energy than a surface having a lower surface energy, the surface energy of the substrate or protective layer may be modified to have a surface energy about the same or greater than the surface energy of the deposited foreign marking substance. In one example, the relative surface energies of a foreign marking comprising fingerprint oil and the surface of a substrate may be optimized to facilitate spreading of the fingerprint oil over the surface of a polymeric protective layer comprising acrylate. The surface energy of the protective layer is the same or greater than the surface energy of the fingerprint oil. Fingerprint oil has a surface tension (i.e., surface energy) of about 29-33 dynes/cm², while the surface energy of an acrylate protective layer is about 30-35 dynes/cm². The similar surface energies enhance spreading such that the fingerprint oil quickly wets and spreads away from the location where the oil was originally deposited as a fingerprint. By forming the protective layer at least partly of a material that provides the protective layer with a surface energy that is the same or greater than that of fingerprint oil facilitates the redistribution of the deposited fingerprint to and throughout the recessed area of the protective layer (i.e., substrate). In some embodiments, other materials having surface energies greater than acrylate may be used to form the protective layer or substrate. In other embodiments, the substrate or protective layer's surface may be treated or coated with an oleophilic material (e.g., by vapor phase deposition) to increase the surface energy and enhance wetting of fingerprint oils.

As a result of the foregoing, embodiments of the present invention make it difficult to accumulate foreign mark substances on the upper surfaces of the microstructures where originally deposited. Reducing the quantity of foreign mark substance that remains on the flat upper surfaces of the microstructures renders the foreign mark imperceptible by a human eye and permits light transmitted or reflected to reach the user with less distortion. For example, by allowing fingerprint oil to spread throughout the recessed area of a protective layer (film) covering an image display, the concentration or mass of oil originally deposited which can cause optical distortion quickly disperses to the recessed area, and the light from an underlying image is able to traverse through the flat upper surfaces of the transparent/translucent microstructures and recessed area with minimal image distortion. In another example, a fingerprint deposited onto a plurality of microstructures of an opaque substrate quickly disperses to the recessed area, thus light reflects off the flat upper surfaces of the opaque microstructures and the recessed area with minimal distortion thereby making the fingerprint imperceptible by a human eye. Furthermore, the rubbing action that may occur during subsequent handling also tends to redistribute the oil to the interstitial recessed areas between microstructures.

Due to typically a lower hardness of polymer substrates or a polymeric protective layer, as compared to glass and metal substrate materials, it is advantageous to utilize elongated microstructures to increase the durability (e.g., shear strength) of the polymeric microstructures on the surface of polymeric substrates. Further durability enhancement may be had by varying the individual microstructure orientation on a substrate surface through the use of elongated curved microstructures.

A suitable density of microstructures on the surface of a substrate or protective layer may be optimized depending upon factors such as the particular application and the normal viewing distance of the viewer to the surface of the substrate. The raised surface areas of the microstructures (i.e., the flat upper surfaces of the plurality of microstructures) are preferably in a range from about 5% to about 45% of the total flat surface area of the substrate (i.e., raised surface area of the microstructures plus recessed surface area(s) of the substrate). At the lower end, a density of microstructures less than about 5% tends to lose the fingerprint resistance of the substrate particularly when the microstructures are short (e.g., h<10 microns). In other words, the microstructures are so far apart that the capillary action between adjacent microstructures deteriorates and thus fingerprint resistance diminishes. In order to maintain fingerprint resistance with a relatively small surface area (i.e., raised surface area), the microstructures would have to be taller (e.g., h>10 microns), as described in more detail below. Whereas at a density greater than about 45%, the excess microstructures do not significantly contribute to the fingerprint resistance of the film and concomitantly the surface area of the recessed area is unnecessarily reduced. Furthermore, microstructure densities greater than 45% can become increasingly complex to fabricate or manufacture due to the requisite small spacing distance between microstructures. The upper density limit of 45% is useful when a plurality of microstructures are formed on a transparent/translucent substrate or protective layer so as not to undesirably introduce an unacceptable amount of haze to the substrate or protective layer. The haze of a transparent substrate (or protective layer) increases proportionally with the sidewall surface area of the plurality of microstructures. As light from an underlying image traverses the substrate, the microstructure's sidewalls tend to scatter the light that impinges upon the sidewalls. This scattered light is re-directed light, which amounts to light loss as perceived by an operator/viewer, and can be quantified or measured as transmission haze. The scattered light also undesirably gives the substrate (or protective layer) a whitish appearance rather than clear. The preferred density range generally correlates with a spacing distance (d) between the nearest portions of any two adjacent microstructures preferably in a range from about 2 microns to about 120 microns, and more preferably in a range from about 10 to 50 microns.

It should be noted that the optimization of microstructure density is also a function of the microstructure height. In general, for taller microstructures a lower density of features may be utilized to provide sufficient fingerprint resistance, whereas for shorter microstructures a higher density of features is used in order to provide sufficient fingerprint resistance. For example, for 8 micron tall microstructures a 15% density of microstructures provides sufficient fingerprint resistance and a density in excess of 25% may cause too much haze in a transparent substrate (or protective layer). In contrast, for 4 micron tall microstructures (with the same length and width dimensions as the 8 micron microstructures) a 20% density of microstructures is used in order to provide sufficient fingerprint resistance and a density in excess of 30% may cause too much haze in a transparent substrate or protective layer. In other words, the taller microstructures provide better fingerprint resistance at lower densities (e.g., 15% density) as compared to the shorter microstructures (e.g., 20% density). Also, in transparent substrate applications, the taller microstructures may introduce an unacceptable amount of haze to a transparent substrate or protective layer at lower densities (e.g., 25% density) due to the increase in sidewall surface area (height×length) of the taller sidewalls at lower densities, as compared to the shorter microstructures (e.g., 30% density). Thus, within the density range of 5% to 45%, the density of microstructures may be further optimized for the particular microstructure geometry and the desired application.

In transparent substrate applications, microstructure sidewall surface area (i.e., the microstructure's length and height) and density of the plurality of the microstructures are parameters to control in order to not introduce an unacceptable amount of haze. The light scattered (e.g., haze) due to the presence of the microstructures on the substrate or protective layer can be measured in order to determine the highest acceptable density of microstructures for a given microstructure geometry. Furthermore, in implementations using two or more layers, e.g., a substrate or protective layer comprising two or more layers, haze may also be reduced by substantially matching the refractive indices of the two or more layers in the multi-layered substrate.

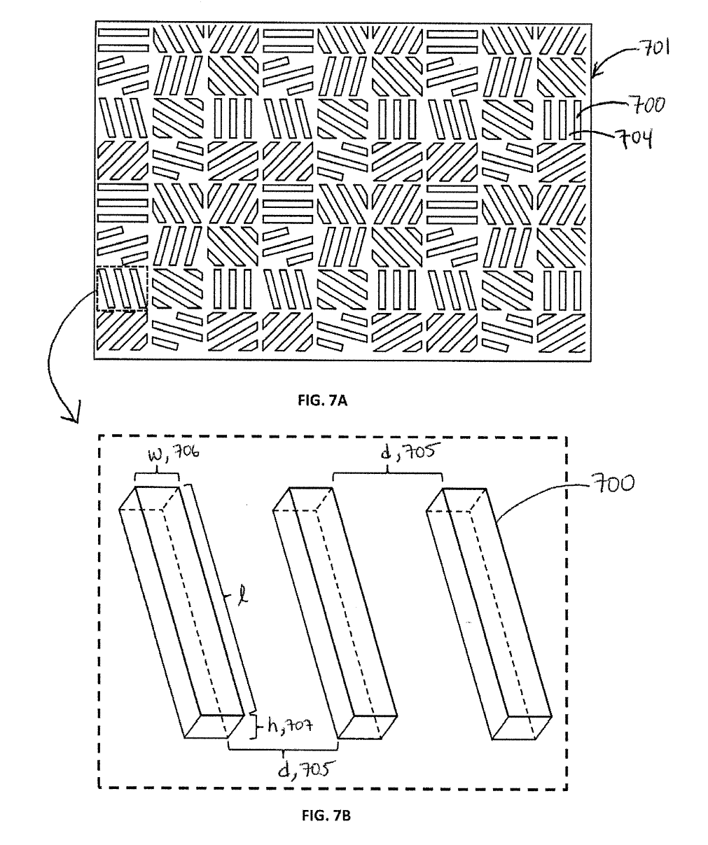

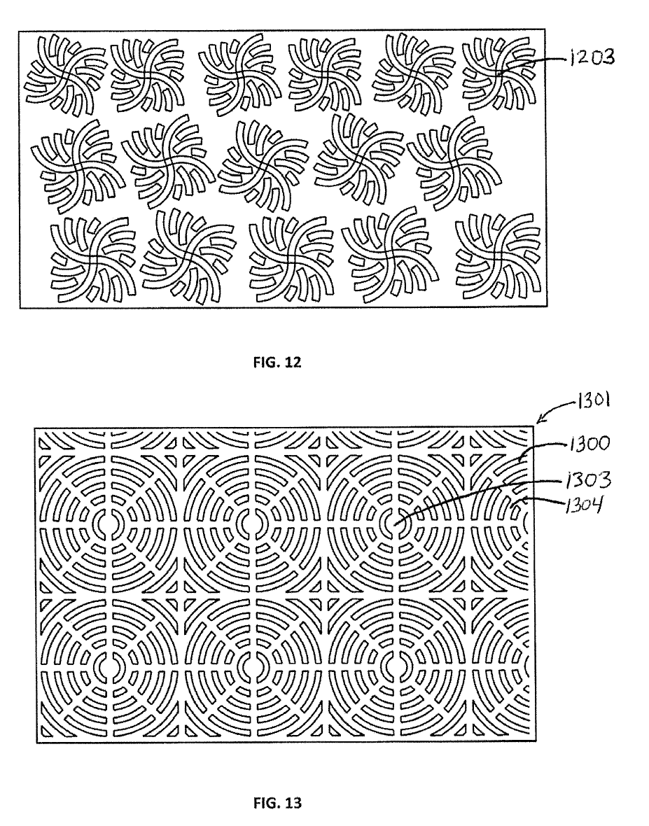

The distribution of the microstructures may be in the form of a regular distribution of microstructures having a constant distance (a) between the center points of adjacent microstructures as depicted in FIGS. 1, 2, and 4-6. Similarly, microstructures may be distributed across the surface of a substrate with a regular distribution in one or more patterns, as illustrated in FIGS. 7-11, 13-15. A pattern refers to a duplicated arrangement of microstructures across the surface of a substrate. The microstructures formed on a substrate (or protective layer) may be arranged in a plurality of pattern orientations, a plurality of pattern sizes, and combinations thereof, as illustrated in FIG. 12 in order to optimize the transmissive or reflective surface property of the substrate for the particular application. In another aspect, the duplicative nature of patterns also aids in the ease of manufacturability of the microstructures on a substrate surface. The size of a single pattern (i.e., the length and width of the pattern) of microstructures may be essentially any size. However, in the case of a transparent protective layer comprising one or more patterns of transmissive microstructures, wherein the protective layer is disposed upon a light-emitting substrate (e.g., an optical display or touch screen panel of a cellular phone), the size and distribution of the pattern of microstructures may be advantageously optimized with respect to the dimensions (i.e., size and distribution) of another pattern (e.g., pixel size) that may exist in the underlying light-emitting substrate so as to avoid creating an interference pattern such as a Moiré pattern.

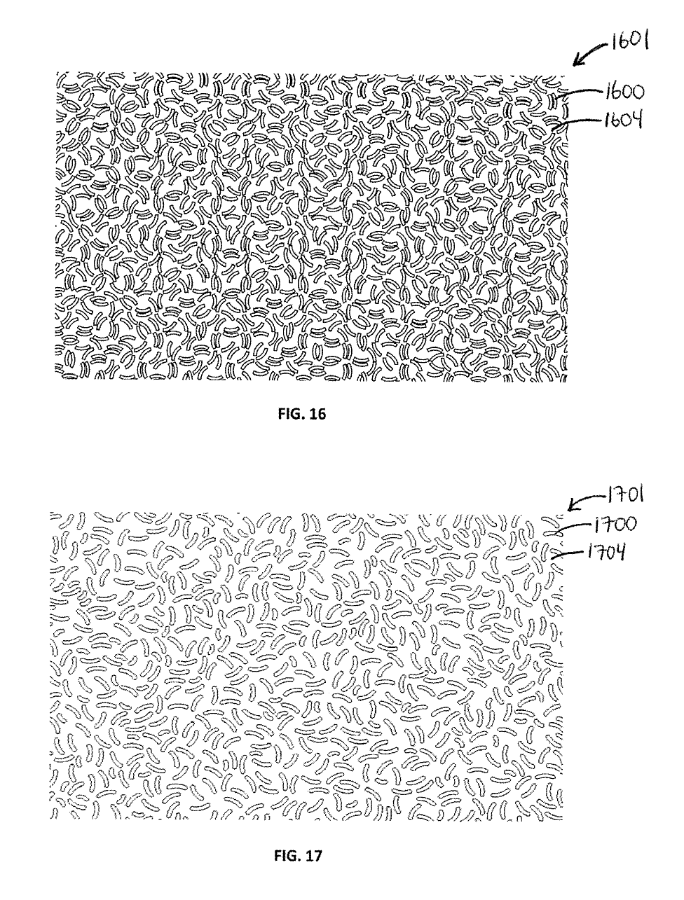

Alternatively, the distribution of the microstructures or the pattern(s) of microstructures may be arranged in a random or near (substantially) random manner on the substrate. As illustrated in FIGS. 16-19, a randomized distribution of microstructures is useful to avoid the appearance of a Moiré pattern when a protective layer is disposed on the surface of an image producing substrate (e.g., optical display). In applications where a randomized distribution of microstructures is desired, smaller length elongated microstructures tend to be easier to distribute in a randomized distribution than longer structures, particularly for microstructure densities greater than about 15%. Thus, an elongated microstructure length to facilitate randomization is in a range from about 35 to 100 microns, and more preferably from about 35 microns to about 75 microns.

### Examples

FIG. 4A is a plan view of a section of a substrate (or protective layer) comprising a regular distribution of cylindrically-shaped microstructures 400 (see FIG. 3A) formed on a top surface of the substrate (or protective layer) 401. It should be noted that each of the Examples described herein is equally applicable to the protective layer. The cylindrical microstructures 400 hide the appearance of foreign marks by reducing light distortion (transmitted and reflected) due to foreign marks, such as oil from fingerprints, deposited onto the flat upper surfaces 402 of the cylindrical microstructures during normal handling of the substrate. The cylindrical microstructures 400 may be formed into a top surface of the substrate 401 by any known processing technique (e.g., patterned and etched, embossed, molded, etc.) as previously described herein. Illustrated in the cross-sectional view of the substrate in FIG. 4B, the spacing distance (d) between adjacent microstructures is in a range from about 2 microns to about 120 microns, and preferably in a range from about 10 to 50 microns. In one example, a planar surface of a glass substrate may be patterned and etched to remove glass material such that cylindrical microstructures 400 are formed and remain on the surface of the substrate 401. In another example, a planar surface of a metal substrate (e.g., a metal sheet) may be etched, embossed, or stamped to form cylindrical microstructures 400 on the surface of the substrate 401. In yet another example, a polymeric substrate (or sheet/film) may be molded, thermally formed, embossed, ablated, etched, or any of a number of polymer processing techniques such as described herein to form cylindrical microstructures 400 on the surface of the substrate 401. The spaced-apart relationship of the individual microstructures provides a surface topography that promotes and allows for the breaking apart and redistribution of the foreign mark substance to the recessed area 404, and thus minimizes the visibility of the foreign mark substance.

FIG. 5 is a plan view of a section of a substrate comprising a regular distribution of pyramidal frustum shaped microstructures 500 formed on a top surface of the substrate or protective layer 501. The microstructures 500 may comprise a regular distribution of microstructures having a constant microstructure orientation, as depicted in FIG. 5, or a regular distribution of microstructures 600 having a substantially random orientation (rotational orientation) as depicted in FIG. 6. The introduction of several orientations, or a substantially random orientation, of the plurality of pyramidal frustum microstructures 600 may be utilized when it is desirable to provide a light diffusing surface (e.g., matte finish) to the surface of a substrate 601. In other words, the different (substantially random) orientations of the pyramidal frustum 600 introduce a greater number of differently angled sidewall surfaces upon which incoming or incident light may be reflected in a broader range of directions thus providing a higher proportion of diffuse reflection. For example, forming frustum microstructures in an opaque substrate hides fingerprints and also may provide a desirable diffusive or matte surface to the opaque substrate. One example of an opaque substrate is a metallic substrate used as the external surface of a refrigerator door. The frustum microstructures in both FIGS. 5 and 6 hide the appearance of foreign marks by reducing light distortion (transmitted or reflected light) due to foreign marks, such as oil from fingerprints, deposited onto the flat upper surfaces of the frustum microstructures during normal handling of the substrate. The frustum microstructures may be formed into a top surface of the substrate by any known processing technique (e.g., patterned and etched, embossed, molded, etc.). The spaced-apart relationship of the individual microstructures provides a surface topography that promotes and allows for the breaking apart and redistribution of the foreign mark substance to the recessed area 504, 604, and thus minimizes the visibility of the foreign mark substance.

FIG. 7A is a plan view of a section of a substrate comprising several patterns of elongated microstructures, wherein each pattern has a plurality of rectangular shaped microstructures 700 (i.e., elongated microstructures) with a different orientation formed on a top surface of the substrate or protective layer 701. The introduction of different orientations, or a substantially random orientation, of the plurality of rectangular microstructures 700 may be utilized to distribute the microstructures formed in a transparent protective layer when it is desirable to prevent the occurrence of Moiré when the protective layer is disposed on an optical display. Alternatively, a substantially random orientation may be utilized to distribute the microstructures formed in an opaque substrate when it is desirable to provide a more uniform light diffusing surface to the substrate. In other words, the different orientations of the rectangular microstructures 700 may introduce a greater number of differently angled surfaces upon which incident light may be reflected in a broader range of directions thus providing a higher proportion of diffuse reflection to the opaque substrate. The rectangular microstructures 700 in FIG. 7A hide the appearance of foreign marks by reducing light distortion (transmitted or reflected) due to foreign marks, such as oil from fingerprints, deposited onto the flat upper surfaces of the rectangular microstructures 700 during normal handling of the substrate. The rectangular microstructures 700 may be formed into a top surface of the substrate 701 by any known processing technique (e.g., patterned and etched, embossed, molded, etc.). The spaced-apart relationship of the individual microstructures provides a surface topography that promotes and allows for the breaking apart and redistribution of the foreign mark substance to the recessed area 704, and thus minimizes the visibility of the foreign mark substance.

FIG. 7B is a cross-sectional schematic of one pattern of rectangular microstructures 700 depicted in FIG. 7A. Referring to FIG. 7B, a suitable spacing distance (d) 705 between adjacent rectangular microstructures 700 may be in a range from about 2 to about 120 microns, and preferably from about 10 to about 50 microns. In one example, a plurality of rectangular elongated microstructures each have a height (h) 707 of 6 microns, a width (w) 706 of 11 microns, and a varying spacing distance (d) 705 between adjacent microstructures in a range from about 10 microns to about 50 microns.

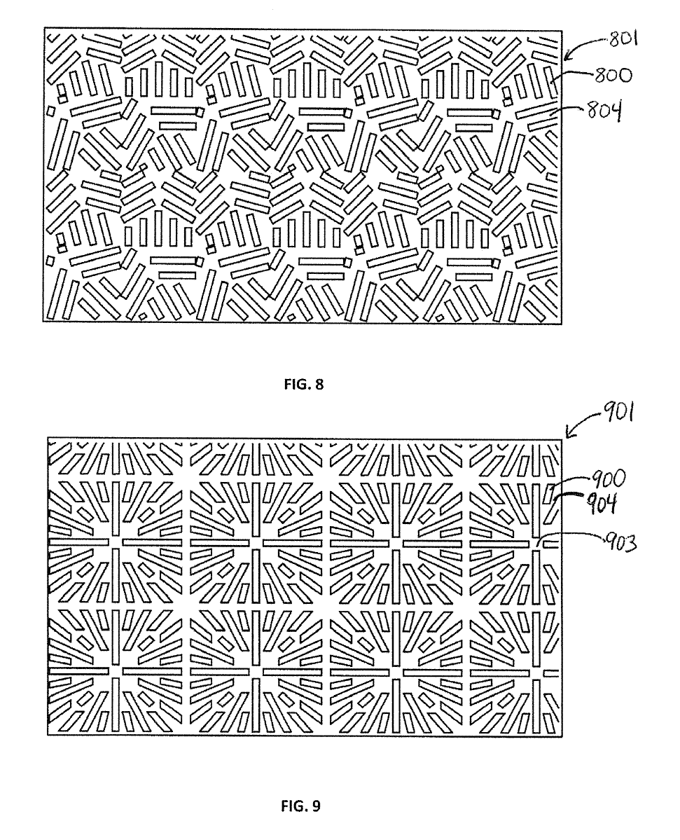

FIG. 8 illustrates a substrate comprising several patterns of microstructures, wherein each pattern has a plurality of rectangular shaped microstructures 800 (i.e., elongated microstructures) with various orientations formed on a top surface of a substrate or protective layer 801. The introduction of different orientations of the plurality of rectangular microstructures 800 within a pattern may be utilized to distribute the microstructures formed in a transparent protective layer when it is desirable to prevent the occurrence of Moiré for the protective layer disposed on an optical display. Alternatively, various orientations of the microstructures may be utilized to distribute the microstructures formed in an opaque substrate when it is desirable to provide a more uniform light diffusing surface to the opaque substrate. The rectangular microstructures 800 in FIG. 8 hide the appearance of foreign marks by reducing light distortion (transmitted or reflected) due to foreign marks, such as oil from fingerprints, deposited onto the flat upper surfaces of the rectangular microstructures 800 during normal handling of the substrate 801. The rectangular microstructures 800 may be formed into a top surface of the substrate 801 by any known processing technique (e.g., patterned and etched, embossed, molded, etc.). The spaced-apart relationship of the individual rectangular microstructures 800 provides a surface topography that promotes and allows for the breaking apart and redistribution of the foreign mark substance to the recessed area 804, and thus minimizes the visibility of the foreign mark substance.

FIG. 9 illustrates another example of a plurality of rectangular shaped elongated microstructures 900 formed on a top surface of a substrate or protective layer 901, the repeating unit of the surface pattern is referred to herein as a ‘linear starburst’ pattern. The linear starburst pattern has the linear rectangular microstructures 900 emanating from a central point 903 (i.e., the center of the unit) in different directions spanning 360 degrees about the central point 903. The introduction of many different orientations of the plurality of rectangular microstructures 900 may be utilized to distribute the microstructures formed in a transparent protective layer when it is desirable to prevent the occurrence of Moiré for the protective layer disposed on an optical display. Alternatively, the many different orientations of the microstructures may be utilized to distribute the microstructures formed in an opaque substrate when it is desirable to provide a more uniform light diffusing surface to the opaque substrate. The rectangular microstructures 900 in FIG. 9 hide the appearance of foreign marks by reducing light distortion (transmitted or reflected) due to foreign marks, such as oil from fingerprints, deposited onto the flat upper surfaces of the rectangular microstructures 900 during normal handling of the substrate 901. The rectangular microstructures 900 may be formed into a top surface of the substrate 901 by any known processing technique (e.g., patterned and etched, embossed, molded, etc.). The spaced-apart relationship of the individual rectangular microstructures 900 provides a surface topography that promotes and allows for the breaking apart and redistribution of the foreign mark substance to the recessed area 904, and thus minimizes the visibility of the foreign mark substance.

FIG. 10 illustrates an example of a plurality of curved elongated microstructures 1000 formed on a top surface of a substrate or protective layer 1001, the repeating unit of the surface pattern is referred to herein as a “curved starburst” pattern. The curved starburst pattern has curved-rectangular shaped microstructures 1000 exhibiting a curved orientation emanating from a central point 1003 (i.e., the center of the unit) in different directions spanning 360 degrees about the central point 1003. This pattern provides a greater number of orientations introduced by both the 360 degree distribution of the plurality of microstructures 1000 and the curved orientations of the rectangular microstructures. The introduction of many different orientations of the plurality of curved-rectangular microstructures 1000 within a pattern may be utilized to distribute the microstructures formed in a transparent protective layer when it is desirable to prevent the occurrence of Moiré for the protective layer disposed on an optical display. Alternatively, the many different orientations of the microstructures may be utilized to distribute the microstructures formed in an opaque substrate when it is desirable to provide a more uniform light diffusing surface to the opaque substrate. In addition, the curved orientation of the curved elongated microstructure 1000 further enhances durability by introducing a varying orientation of a single microstructure 1000 such that an applied shear force is distributed along both the width and length dimensions of the curved microstructure 1000. The curved rectangular microstructures 1000 in FIG. 10 hide the appearance of foreign marks by reducing light distortion (transmitted and reflected) due to foreign marks, such as oil from fingerprints, deposited onto the curved flat upper surfaces of the microstructures 1000 during normal handling of the substrate 1001. The microstructures 1000 may be formed into a top surface of the substrate by any known processing technique (e.g., patterned and etched, embossed, molded, etc.). The spaced-apart relationship of the individual microstructures 1000 provides a surface topography that promotes and allows for the breaking apart and redistribution of the foreign mark substance to the recessed area, and thus minimizes the visibility of the foreign mark substance.

FIG. 11 illustrates an alternative embodiment of the curved starburst pattern. As compared to FIG. 10 above, the curved starburst pattern depicted in FIG. 11 has additional curved-rectangular shaped microstructures 1100 emanating from a central point 1103 (i.e., the center of the unit) in different directions spanning 360 degrees about the central point 1103. The introduction of more orientations of the plurality of rectangular microstructures 1100 within a single pattern may be utilized to better reduce the appearance of Moiré when the microstructures are formed in a transparent substrate disposed on an optical display, or to provide a more uniform light diffusing surface when the microstructures are formed in an opaque substrate. In another aspect, the additional curved rectangular shaped microstructures may be utilized to provide a smaller range of spacing distance (d) between adjacent microstructures within the pattern.

FIG. 12 illustrates an alternative embodiment of the curved starburst pattern. As compared to FIG. 11 above, the curved starburst pattern depicted in FIG. 12 may be distributed with different (substantially random) orientations about their center points 1203. In addition, the patterns may be disposed with different pattern sizes, for example the pattern size increases from the top row to the bottom row as shown in FIG. 12. Furthermore, the spacing between adjacent patterns may be varied across the surface of the substrate. The introduction of different orientations, sizes, and spacing of a pattern (or several patterns) may be utilized to distribute the microstructures formed in a transparent protective layer when it is desirable to prevent the appearance of Moiré for the protective layer disposed on an optical display. Alternatively, the many different pattern orientations, sizes and spacing may be utilized to distribute the microstructures formed in an opaque substrate when it is desirable to provide a more uniform light diffusing surface to the opaque substrate.

FIG. 13 illustrates another example of a plurality of curved elongated microstructures 1300 formed on a top surface of a substrate or protective layer 1301, the repeating unit of the surface pattern is referred to herein as a “broken-ring” concentric pattern. The broken ring concentric pattern has curved-rectangular shaped microstructures 1300 with a curved orientation having a common central point 1303 (i.e., the center of the unit) spanning 360 degrees about the central point 1303. The introduction of the many orientations spanning 360 degrees within a single pattern may be utilized to distribute the microstructures formed in a transparent protective layer when it is desirable to prevent the occurrence of Moiré for the protective layer disposed on an optical display. Alternatively, the many different orientations of the microstructures may be utilized to distribute the microstructures formed in an opaque substrate when it is desirable to provide a more uniform light diffusing surface to the opaque substrate. In addition, the curved orientation of the curved elongated microstructure 1300 further enhances durability by introducing a varying orientation of a single microstructure such that an applied shear force is distributed along both the width and length dimensions of the curved microstructure 1300. The curved rectangular microstructures 1300 in FIG. 13 hide the appearance of foreign marks by reducing light distortion (transmitted and reflected) due to foreign marks, such as oil from fingerprints, deposited onto the curved flat upper surfaces of the microstructures 1300 during normal handling of the substrate 1301. The microstructures may be formed into a top surface of the substrate 1301 by any known processing technique (e.g., patterned and etched, embossed, molded, etc.). The spaced-apart relationship of the individual microstructures provides a surface topography that promotes and allows for the breaking apart and redistribution of the foreign mark substance to the recessed area 1304, and thus minimizes the visibility of the foreign mark substance.

FIG. 14 illustrates an alternative embodiment of the broken ring concentric pattern. As compared with FIG. 13 above, the broken ring concentric pattern depicted in FIG. 14 has curved elongated microstructures 1400 emanating from a central point 1403, without including the microstructures that do not form substantially complete concentric rings. The spaced-apart relationship of the individual microstructures provides a surface topography that promotes and allows for the breaking apart and redistribution of the foreign mark substance to the recessed area 1404, and thus minimizes the visibility of the foreign mark substance.

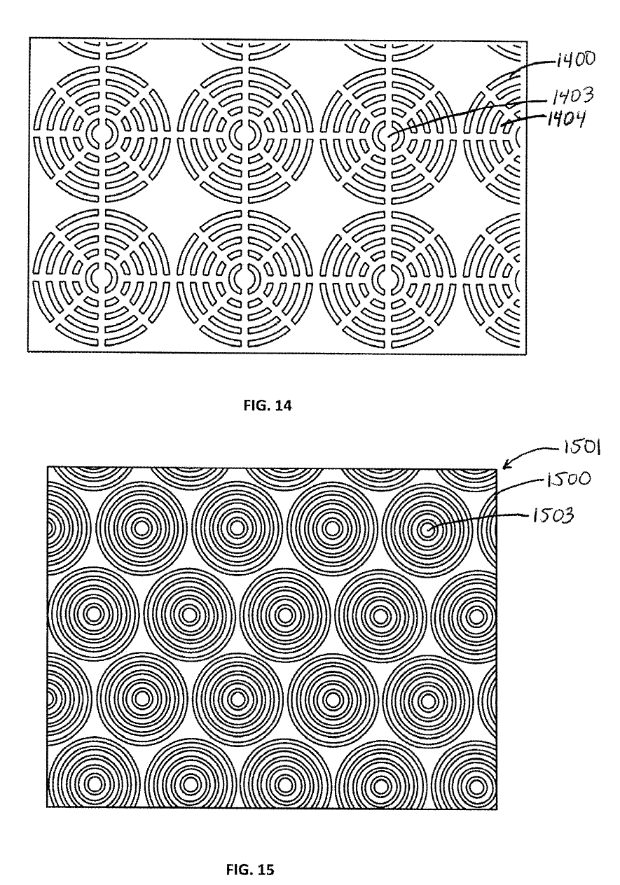

FIG. 15 illustrates an alternative embodiment of the concentric pattern. As compared with FIGS. 13 and 14 above, the concentric pattern depicted in FIG. 15 has continuous (i.e., non-broken) concentric ring shaped microstructures 1500 emanating from a central point 1503, wherein the pattern is distributed on the substrate 1501 in a hexagonal close packed distribution. The concentric pattern has ring shaped microstructures 1500 with a curved orientation having the common central point 1503 (i.e., the center of the unit) spanning 360 degrees about the central point 1503. The introduction of all orientations (i.e., 360 degrees) of the plurality of curved-rectangular microstructures 1500 within a single pattern may be utilized to better reduce the appearance of Moiré when the microstructures are formed in a transparent substrate disposed on an optical display, or to provide a more uniform light diffusing surface when the microstructures are formed in an opaque substrate. Furthermore, arranging the microstructures in a close-packed configuration may also be utilized to better reduce the appearance of Moiré when the microstructures are formed in a transparent substrate disposed on an optical display, or to provide a more uniform light diffusing surface when the microstructures are formed in an opaque substrate.

FIG. 16 illustrates a plurality of curved elongated microstructures 1600 formed on a top surface of a substrate or protective layer 1601, wherein the surface pattern is referred to herein as a “chromosome” pattern. The chromosome pattern has curved-rectangular shaped microstructures 1600 in a substantially random distribution. In some embodiments, the curved-rectangular microstructures 1600 may be formed as groups of two or more neighboring microstructures. The introduction of the groupings and substantially random distribution of the chromosome pattern may be utilized to distribute the microstructures formed in a transparent protective layer when it is desirable to prevent the occurrence of Moiré for the protective layer disposed on an optical display. Alternatively, the random distribution and curved orientation of the microstructures may be utilized to distribute the microstructures formed in an opaque substrate when it is desirable to provide a more uniform light diffusing surface to the opaque substrate. The curved-rectangular microstructures 1600 in FIG. 16 hide the appearance of foreign marks by reducing light distortion (transmitted and reflected) due to foreign marks, such as oil from fingerprints, deposited onto the curved flat upper surfaces of the microstructures 1600 during normal handling of the substrate 1601. The curved-rectangular microstructures 1600 may be formed into a top surface of the substrate 1601 by any known processing technique (e.g., patterned and etched, embossed, molded, etc.). The spaced-apart relationship of the individual curved elongated microstructures 1600 provides a surface topography that promotes and allows for the breaking apart and redistribution of the foreign mark substance to the recessed area 1604, and thus minimizes the visibility of the foreign mark substance.

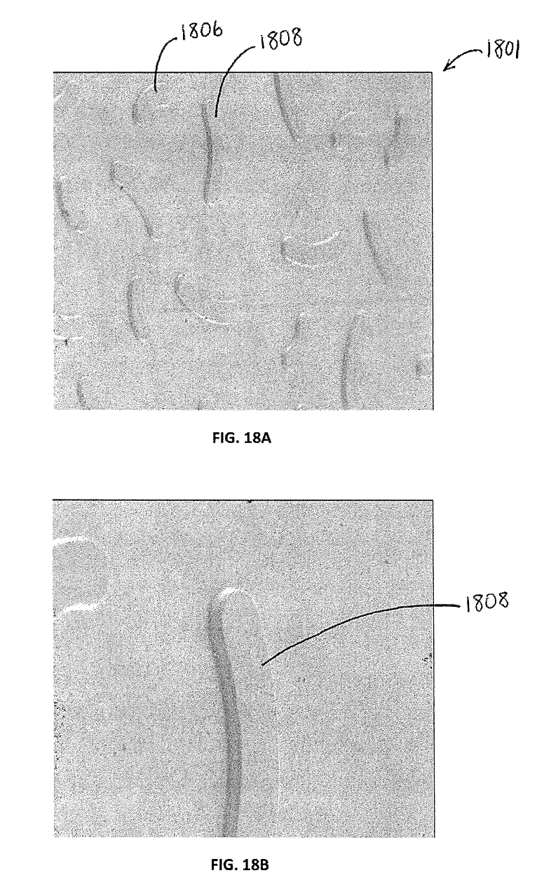

FIG. 17 illustrates an alternative embodiment of a plurality of curved elongated microstructures utilizing a bimodal population of microstructures, wherein the microstructures are referred to herein as “hot-dog” shaped microstructures. The hot-dog shaped microstructures 1700 having a curved orientation are distributed on the surface of the substrate 1701 in a substantially random distribution. In some embodiments, for a given density, a population of uniformly sized smaller structures (e.g., a length×width×height of 45×15×4 microns) may be easier to distribute in a substantially randomized distribution than longer structures (e.g., a length×width×height of 75×15×4 microns), particularly for elongated microstructure densities above 15%. As such, bimodal populations of microstructures (two different sizes of such microstructures, though the present invention is not limited to utilization of only one or two sizes), that introduces a second smaller length elongated microstructure may be utilized to in order to facilitate randomization of the microstructures for the purpose of substantially preventing Moiré. The introduction of randomized curved elongated microstructures 1700 is utilized to prevent the occurrence of Moiré when the microstructures are formed in a transparent substrate disposed on an optical display, or to provide a more uniform light diffusing surface when the microstructures are formed in an opaque substrate. The curved elongated microstructures 1700 hide the appearance of foreign marks by reducing light distortion (transmitted and reflected) due to foreign marks, such as oil from fingerprints, deposited onto the curved flat upper surfaces of the microstructures 1700 during normal handling of the substrate 1701. The spaced-apart relationship of the individual curved elongated microstructures 1700 provides a surface topography that promotes and allows for the breaking apart and redistribution of the foreign mark substance to the recessed area 1704, and thus minimizes the visibility of the foreign mark substance.

The curved elongated microstructures 1700 may be formed into a top surface of the substrate 1701 by any known processing technique (e.g., patterned and etched, embossed, molded, etc.). In the illustrated example, the curved elongated microstructures 1700 have rounded ends. In some manufacturing implementations, forming the microstructures with rounded ends may improve the manufacturability of the elongated microstructures on a substrate or protective layer when compared to the manufacturability of microstructures with squared ends (e.g., as illustrated by the curved elongated microstructures 1600 in the chromosome pattern depicted in FIG. 16). FIG. 18A is a SEM micrograph of a bimodal population of hot-dog shaped microstructures comprising a plurality of shorter hot-dog shaped microstructures 1806 having a length×width×height of 45×15×4 microns and a plurality of longer hot-dog shaped microstructures 1808 have a length×width×height of 75×15×4 microns. As depicted, the bimodal population of hot-dog shaped structures are distributed on the surface of a transparent protective layer 1801 in a random distribution. The random distribution of the hot-dog shaped microstructures 1806, 1808 formed in the transparent protective layer 1801 prevents the appearance of Moiré when the protective layer is disposed on an optical display. FIG. 18B is an enlarged view of a portion of the SEM micrograph shown in FIG. 18A. This enlarged view clearly shows the vertical sidewalls and the rounded opposing ends of the hot-dog shaped microstructure 1808.

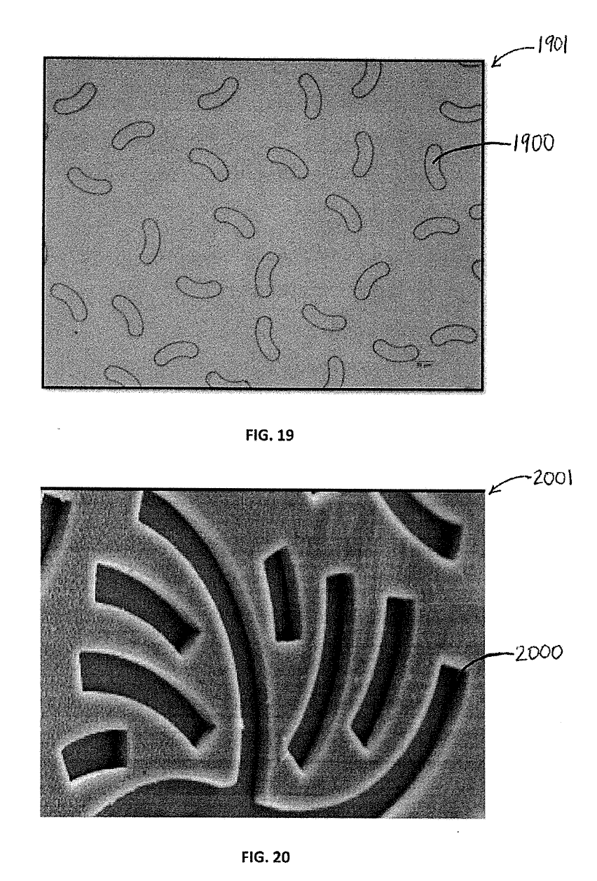

FIG. 19 is a SEM micrograph illustrating another example of the curved elongated microstructure utilizing a single population (i.e., uniformly sized) of hot-dog shaped microstructures 1900. The hot-dog shaped microstructures 1900 have a length×width×height of 45×15×4 microns and are distributed on the surface of the substrate 1901 in a substantially random distribution. With a relatively short elongated microstructure length of 45 microns, these hot-dog shaped microstructures 1900 are relatively easy to distribute in a substantially randomized distribution over the surface of the substrate 1901 or protective layer for microstructure densities up to about 45%.

In many of the previous examples, the microstructures have been generally described as structures that project outward from a base surface (e.g., plateaus rising above a flat plane). But in other implementations, the microstructures can be formed in the inverse. For example, the microstructures may be formed as sharply defined depressions in an otherwise substantially flat surface (e.g., trenches cut into a plane). These depressions can be formed with dimensions substantially similar to the raised microstructures. For example, a suitable depth for each of the microstructures may be in the range between about 1 and about 25 microns, more preferably in a range between about 3 and about 10 microns. A suitable width for each of the microstructures may be in the range of about 2 microns to about 120 microns, more preferably in a range between about 10 and about 50 microns. A suitable aspect ratio of width to depth for each of the microstructures may be in the range of about 1 to about 13. A suitable length for each the microstructures may be in a range from about 10 to about 250 microns, more preferably in the range from about 35 microns to about 100 microns. A suitable distance (d) (i.e., spacing) between the nearest portions of any two adjacent microstructures may be in a range from about 2 to about 120 microns, more preferably in the range between about 10 and about 50 microns. A suitable percentage of the surface area of the depressed surface features should be in a range of about 5% to 45% of the total flat surface area (i.e., the depressed or recessed flat surface area plus the raised flat surface area surrounding the recessed microstructures). In one example, a plurality of rectangular microstructures each have a depth of 6 microns, a width of 11 microns, and a varying distance (d) between adjacent microstructures in a range from about 10 microns to about 50 microns. FIG. 20 is a SEM micrograph of recessed curved elongated microstructures 2000 in the curved starburst pattern, previously described with reference to FIG. 11, formed in the top surface of a substrate 2001.

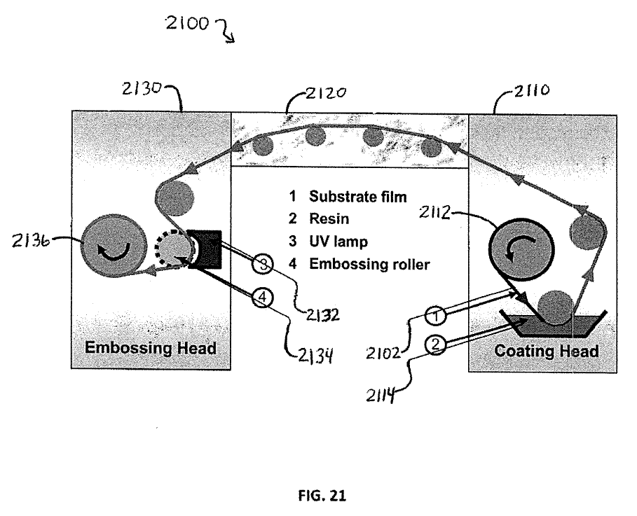

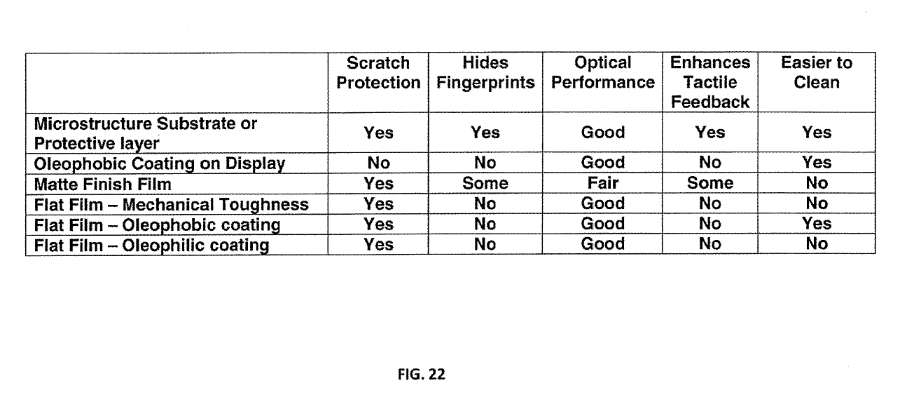

FIG. 21 illustrates an example roll to roll embossing system 2100 for manufacturing a substrate 2102 having a plurality of microstructures (e.g., such as the microstructures discussed in the descriptions of FIGS. 1-20) distributed on a top surface of the substrate 2102. In some implementations, the system 2100 may be used to manufacture elongated sheets or rolls of micropatterned substrate or protective layers in a substantially continuous process.

The system 2100 includes a coating module 2110, a drying module 2120, and an embossing module 2130. The coating module 2110 accepts a roll 2112 of unpatterned substrate 2102 (e.g., polyethylene terephthalate film (PET) film). In some embodiments, the roll 2112 of unpatterned substrate 2102 may be replaced by another form of supply of unpatterned substrate 2102 for coating. For example, unpatterned substrate 2102 may be supplied as flat sheets, in which case a sheet feeder mechanism may be implemented. In another example, unpatterned substrate 2102 may be supplied in fanfold form (e.g., like computer paper), wherein the substrate 2102 is presented as substantially flat sheets that are periodically folded to form a zigzag pattern.

The coating module 2110 includes a supply of a resin 2114 (e.g., ultraviolet curable acrylate) that is applied to the substrate 2102. In some implementations, the substrate 2102 may be cleaned prior to the application of the resin 2114. The resin 2114 may be applied in a variety of ways. For example, the substrate 2102 may be passed through, or be dipped in a bath of the resin 2114, thereby coating the substrate. In other implementations, the resin 2114 may be sprayed, rolled, brushed, or otherwise deposited onto the substrate 2102.

The substrate 2102 passes through the drying module 2120. In some implementations, the drying module 2120 can dry or partially dry, heat, cure, or otherwise process the resin 2114 that was previously applied to the substrate 2102 by exposing the substrate 2102 to heat or ultraviolet (UV) radiation. In some implementations, by at least partly drying or curing the resin 2114, it may become bonded to the substrate 2102.

The substrate 2102 is processed by an embossing module 2130. The embossing module 2130 includes an ultraviolet (UV) lamp 2132 and an embossing roller 2134. In some implementations, the embossing roller 2134 is sleeved by a master shim covered by an inverted (e.g., negative) pattern of microstructures such as the microstructures previously discussed in the descriptions of FIGS. 1-20. In some embodiments, the inverse pattern of microstructures may be formed using a photolithographic process. For example, a master shim's substrate may be cleaned and coated with a photoresist material, and may then be pre-cured by baking or exposure to UV light. The desired microstructure pattern may then be transferred onto pre-cured photoresist by using a projected image or an optical mask. The photoresist can be developed (e.g., etched) by standard photolithography techniques to form a patterned resist of the desired microstructures, after which the patterned resist can be post-cured. The patterned photoresist material can then be coated with a metal (e.g., copper) to make the surface conductive, and then nickel can be electroplated onto the metal-coated patterned resist thereby forming a nickel master shim. The nickel master shim can then be separated from the substrate so it can be wrapped around a drum to form the embossing roller 2134.

The embossing roller 2134 is brought into rolling contact with the resin 2114 coating on the substrate 2102. As the embossing roller 2134 rolls over the substrate 2102, the inverted pattern of microstructures is impressed into the resin 2114 coating. The UV lamp 2134 cures the resin 2114 causing it to at least partly harden, thereby preserving the patterns of microstructures impressed into the resin 2114. The substrate 2102 may be molded, thermally formed, embossed, etched, or otherwise be patterned using any of a number of polymer processing techniques to form the microstructures on a surface of the protective layer. The substrate 2102 is taken up by a roll 2136. In some implementations, the roll 2136 can be replaced by a receptacle for separated sheets, fan-folded sheets, or other forms of the substrate 2102 after processing. In some implementations, once the substrate 2102 has been processed, an adhesive and a protective liner can be applied to the smooth (e.g., unpatterned) side of the substrate 2102. In some implementations, the substrate 2102 can be cut to a desired size. For example, the substrate 2102 can be cut into pieces that substantially cover the image surface of an optical display.

As previously mentioned, embodiments of the protective layer may be fabricated with essentially any polymer that may be processed to form a plurality of microstructures (e.g., curved elongated microstructures) in a surface of the protective layer. A few suitable polymers include polyethylene terephthalate (PET), acrylics, silicones, and urethanes. The material and thickness of the protective layer may be optimized in accordance with the particular application and/or anticipated degree of handling required to provide adequate durability. In one example, a 20 micron thick protective layer made of acrylate may be fabricated with a plurality of curved elongated microstructures (e.g., a concentric broken rings pattern) formed on a top surface of the layer using a molding process. The elongated curved microstructures have a height of about 4 microns, a width of about 8 microns, and a distance between adjacent microstructures of about 11 microns. The smooth side of the protective layer may be positioned or mounted onto a cellular phone touch-pad, typically a transparent glass substrate, to provide fingerprint resistance to the touch-pad with no loss of touch pad functionality.

The second surface, also referred to as a smooth side, of the protective layer is disposed onto another substrate (e.g., a transparent substrate). The smooth side may be optionally coated with a low-tack adhesive to reduce unwanted movement of the protective layer during use. Alternatively, the smooth side may be electrostatically charged to cling to the transparent substrate. The low-tack adhesive and electrostatic charge allows for ease of placement, adjustability, and allows the protective layer to be easily replaced when needed (i.e., disposable).

In addition to having a surface topography to reduce handling contamination effects (e.g., fingerprint effects), the protective layer and/or substrate of the embodiments of the present invention may also have other desirable attributes characteristic of, for example, privacy films (viewing angle reduction), brightness enhancement films (redirect optical energy towards primary viewing angles), anti-reflective films (e.g., having a antireflective coating or retro-reflective structures), scratch resistant films, self-cleaning surfaces (e.g., using self-assembled monolayer coatings), anti-microbial films, and/or anti-static films, to name a few.

For example, to provide hardness or scratch resistance to the polymeric protective layer or substrate, hard particles such as sapphire, silicon oxide (e.g., SiO₂), and titanium oxides, to name a few, may be added to the polymer resin during fabrication of the microstructures to impart good abrasion and wear resistance to the microstructure surface of the substrate (or protective layer). The hard particles have a particle size smaller than the wavelength of light (i.e., nanoparticles) such that the particles are transparent when incorporated into the protective layer (i.e.; transparent protective layer). During fabrication of the microstructures, these hard particles tend to uniformly disperse and migrate to the surface of the protective layer thereby imparting good abrasion and wear resistance to the microstructure surface of the protective layer.

In another example, the attribute of anti-reflection or anti-glare may be imparted to the protective layer or substrate by depositing an anti-reflection coating onto the plurality of microstructures and top surface of the protective layer or substrate (i.e., coating the plurality of microstructures and recessed area). Suitable anti-reflection coatings comprise materials having a low index of refraction in a range from about 1 to about 1.35. Exemplary materials include magnesium fluoride or fluoropolymers having an index of refraction of about 1.3.

In another example, the attribute of a self-cleaning surface may be imparted to the protective layer or substrate by depositing a self-assembled monolayer (SAM) comprising a fluorinated or chlorofluoro functional polymeric monolayer onto the plurality of microstructures and top surface of the protective layer or substrate. The application of these topical monolayers can dramatically increase the surface energy such that the surface exhibits both hydrophobic and oleophobic properties. The hydrophobic and oleophobic surface properties enhance fingerprint removal. In another example, the attribute of self-cleaning may be imparted to the protective layer or substrate by depositing a hydrophilic SAM comprising a hydroxyl, carboxylic or polyol functional monolayer onto the plurality of microstructures and top surface of the protective layer or substrate. The hydrophilic monolayer imparts a low surface energy such that water is attracted to the surface and coalesces to form droplets that may run off the surface washing away surface contaminants.

In another example, the attribute of an antimicrobial surface may be imparted to a polymeric protective layer or substrate by adding one or more biocides to the polymer resin during fabrication of the microstructures on the surface of the protective layer or substrate. Illustrative biocides are silver nanoparticles and triclosan.

In another example, the attribute of an antistatic surface may be imparted to a polymeric protective layer or substrate by adding one or more hydrophilic additives to the polymer resin during fabrication of the microstructures on the surface of the protective layer or substrate. This surface property is particularly useful for a polymeric protective layer or a substrate material (e.g., polymer, glass) susceptible to triboelectric charging. For example, static charge can be transferred from a finger tip to the surface of the protective layer (or substrate) during contact or handling (e.g., rubbing) of the surface. Suitable hydrophilic additives include quaternary amines and polyethylene glycols. A sufficient amount of hydrophilic additive is incorporated into the polymeric protective layer or substrate to decrease the electrical volume resistivity of the polymeric resin to a volume resistivity of less than about 10¹² ohm-cm, and preferably in a range from about 10⁹ to 10¹¹ ohm-cm. For these materials, electrons may flow across the surface and through the bulk material to dissipate otherwise static charge.

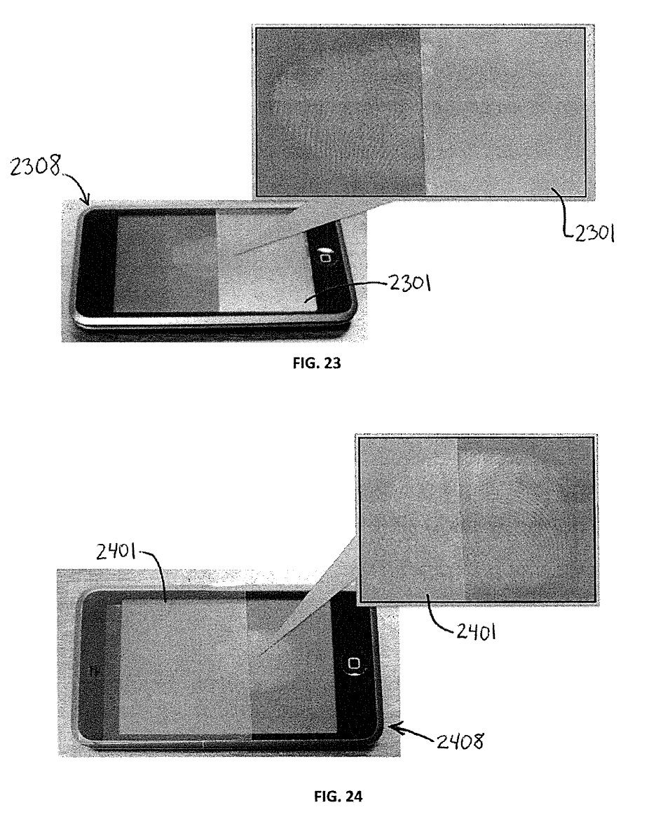

Referring to FIG. 23, to test the fingerprint resistance of an example of the protective layer, a sheet of substrate (i.e., a protective layer) 2301 having previously described microstructures was fitted over the right-hand side of a cellular phone display 2308. A single fingerprint was deposited spanning both the bare display on the left-hand side and the protective layer 2301 in order to deposit approximately half of the fingerprint onto the bare display and the other half onto the protective layer 2301. The result is a substantially non-detectable fingerprint on the protective layer 2301, demonstrating the fingerprint resistance provided by the pattern of microstructures. In this example, the protective layer 2301 utilized a chromosome pattern of substantially randomized microstructures, such as those previously described in the discussion of FIG. 16. The microstructures in the present example were given a density of about 22.5%, and their dimensions were approximately 120 microns long, 34 microns wide, and 4 microns high.

FIG. 24 illustrates an example of the fingerprint resistance of another protective film 2401. As in FIG. 23, the protective film 2401 was cut to cover half of the display of a cell phone 2408 (in this example, the left-hand side), and a fingerprint was deposited such that half the fingerprint was deposited on the bare display on the right-hand side and the other half on the protective layer 2401. The protective layer 2401 of the present example was given a microstructure density of about 15%, and demonstrated less fingerprint resistance than the protective layer 2301 in FIG. 23. Therefore, for 4 micron tall microstructures, a preferred density range is from about 15% to about 35%, and more preferably in a range from about 20% to about 30%.

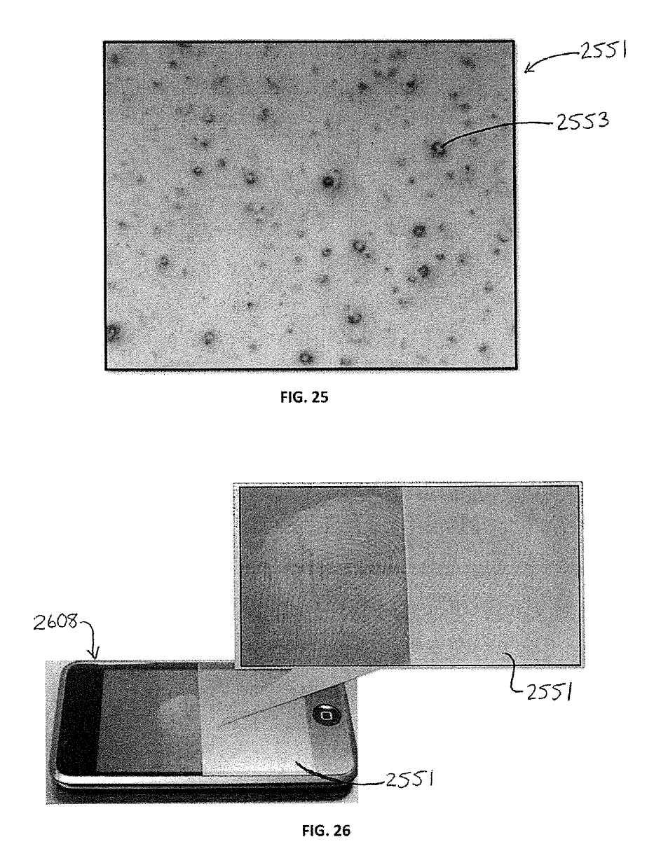

Tests similar to those performed and illustrated by FIGS. 23 and 24 were also performed with two commercially available products. One product was a film 2551 made by Power Support of Burbank, Calif. The product's packaging states that the film 2551 is an “anti-glare film” and that it resists smudges and fingerprints. The enlarged view of the film 2551 as shown in FIG. 25 shows that it has a matte finish and a substantially random surface roughness, with a peak-to-valley (Rₜ) dimension of about 5.7 microns and an average surface roughness (Rₐ) of about 0.4 microns as measured by optical interferometry. The film 2551 was cut to cover half of the display of a cell phone 2608 (in this example, the right-hand side), and a fingerprint was deposited such that half the fingerprint was deposited on the bare display on the left-hand side and the other half on the film 2551, as demonstrated in FIG. 26. The fingerprint resistance is poor because the deposited fingerprint, although reduced in appearance as compared with the bare display surface, is still visible by a viewer. In addition, the opaque micron-sized fillers 2553 in the film 2551 cause haze and a reduction in the optical quality of an image emitted from an underlying optical display of the cell phone 2608.

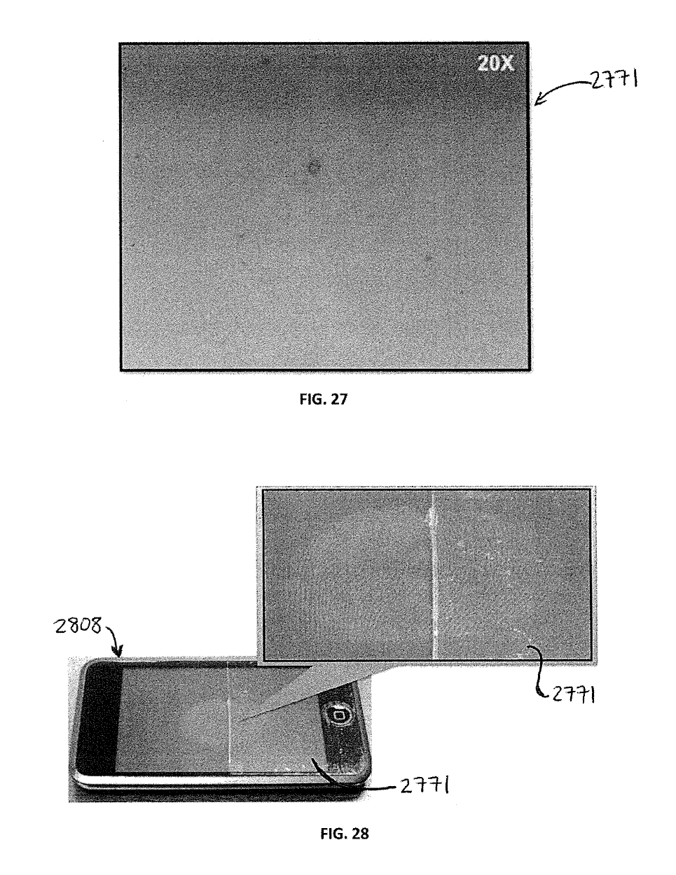

Referring to FIGS. 27 and 28, the other product tested was a smooth film 2771 called “Invisi-Shield,” commercially available from Zagg, Inc., of Salt Lake City, Utah. FIG. 27 illustrates an enlarged view of the film 2771, which has a peak-to-valley surface roughness (Rₜ) of about 1.5 microns and an average surface roughness (Rₐ) of about 0.06 microns as measured by optical interferometry. The film 2771 was cut to cover half of the display of a cell phone 2808 (in this example, the right-hand side), and a fingerprint was deposited such that half the fingerprint was deposited on the bare display on the left-hand side and the other half on the film 2771, as demonstrated in FIG. 28. The Zagg, Inc., product is advertised as a “scratch resistant” film that makes no known claims for fingerprint resistance. As such, the film 2771 demonstrates almost no fingerprint resistance.

In general, matte films with intentional, substantially random surface roughness of about 5.7 microns (e.g., the film illustrated in FIGS. 25 and 26) demonstrate poor fingerprint resistance and optical performance, whereas substantially smooth films do not demonstrate any appreciable resistance to fingerprints (e.g., the film illustrated in FIGS. 27 and 28). However, the introduction of microstructures onto a protective layer in accordance with embodiments of the present invention results in a surface that demonstrates very good fingerprint resistance, as was shown previously in the example illustrated by FIG. 23.

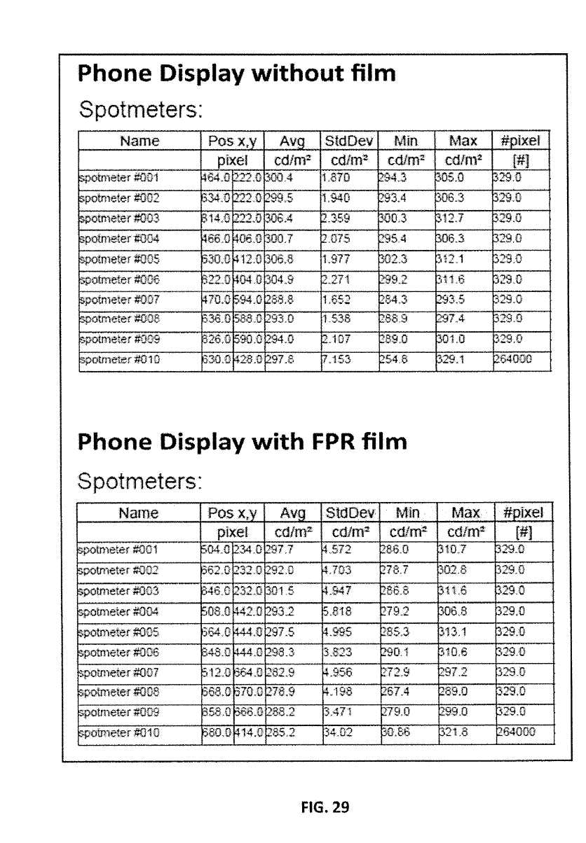

FIG. 29 depicts two tables of luminance data. The first table includes a collection of luminance measurements taken on a bare cellular telephone display, and the second table includes similar measurements taken on the same cellular display, but covered by an exemplary protective layer (i.e., “FPR film”) patterned with microstructures in accordance with embodiments of the present invention. Luminance was measured on the display with and without the protective layer. From the measurements shown, the protective layer used in the present example exhibited a high degree of luminance performance with only about 2.4% light loss.

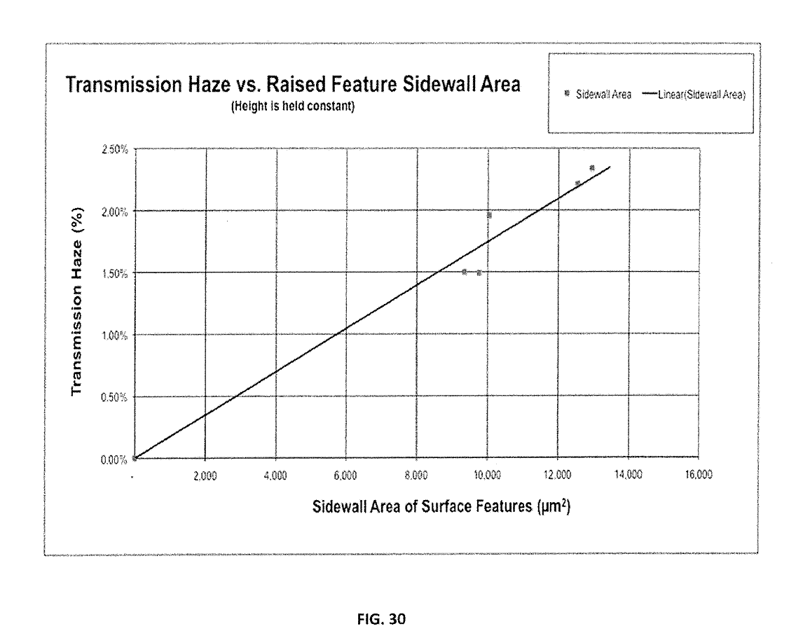

In another experiment, the haze of a protective layer having a bimodal population of curved, elongated structures with rounded ends (e.g., hot dog shaped structures measuring approximately 75×15×4 microns and approximately 45×15×4 microns, such as illustrated in FIGS. 17 and 18A) was measured over an area of approximately 420×320 microns. A plot of the haze transmitted through the protective layer as a function of the sidewall surface area (e.g., the vertical surface area of the hot dog shaped structures) is illustrated in FIG. 30. For a given height (e.g., approximately 4 microns in this example) the plot illustrates that as the density of microstructures increases, so too does the amount of haze. In some embodiments, the density of microstructures on the protective layer for an optical display may be limited so as not to exhibit an undesirable amount of haze.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A fingerprint resistant substrate comprising a plurality of curved elongated microstructures and an interstitial area between adjacent microstructures of said plurality of curved elongated microstructures formed in an exterior surface of the substrate, wherein each of the plurality of microstructures has a flat upper surface and vertical or near vertical sidewalls, wherein the interstitial area between adjacent microstructures is a recessed area configured to permit fluid migration throughout the recessed area.

2. The fingerprint resistant substrate of claim 1, wherein each of the plurality of curved elongated microstructures has a length greater than a width.

3. The fingerprint resistant substrate of claim 2, wherein each of the plurality of curved elongated microstructures is curved along its length.

4. The fingerprint resistant substrate of claim 1, wherein each of the plurality of curved elongated microstructures has a height in a range from about 1 micron to about 25 microns.

5. The fingerprint resistant substrate of claim 4, wherein each of the plurality of curved elongated microstructures has a height in a range from about 3 microns to about 10 microns.

6. The fingerprint resistant substrate of claim 1, wherein each of the plurality of curved elongated microstructures has a width in a range from about 2 microns to about 120 microns.

7. The fingerprint resistant substrate of claim 6, wherein each of the plurality of curved elongated microstructures has a width in a range from about 10 microns to about 50 microns.

8. The fingerprint resistant substrate of claim 4, wherein each of the plurality of curved elongated microstructures has a width in a range from about 2 microns to about 120 microns.

9. The fingerprint resistant substrate of claim 8, wherein each of the plurality of curved elongated microstructures has an aspect ratio of width to height (W:H) in a range from about 1 to about 13.

10. The fingerprint resistant substrate of claim 1, wherein each of the plurality of curved elongated microstructures has a length in a range from about 10 microns to about 250 microns.

11. The fingerprint resistant substrate of claim 10, wherein each of the plurality of curved elongated microstructures has a length in a range from about 35 microns to about 100 microns.

12. The fingerprint resistant substrate of claim 8, wherein each of the plurality of curved elongated microstructures has a length in a range from about 10 microns to about 250 microns.

13. The fingerprint resistant substrate of claim 1, wherein a distance between nearest portions of any two adjacent microstructures of the plurality of curved elongated microstructures is in a range from about 2 microns to about 120 microns.

14. The fingerprint resistant substrate of claim 13, wherein the distance between nearest portions of any two adjacent microstructures of the plurality of curved elongated microstructures is in a range from about 10 microns to about 50 microns.

15. The fingerprint resistant substrate of claim 8, wherein a distance between nearest portions of any two adjacent microstructures of the plurality of curved elongated microstructures is in a range from about 2 microns to about 120 microns.

16. The fingerprint resistant substrate of claim 1, wherein the density of the plurality of curved elongated microstructures is such that the flat upper surfaces of the plurality of curved elongated microstructures has a surface area in a range from about 5% to about 45% of a planar surface area of the substrate's exterior surface, wherein the planar surface area is a summation of the surface area of the flat upper surfaces and the recessed area.

17. The fingerprint resistant substrate of claim 8, wherein the density of the plurality of curved elongated microstructures is such that the flat upper surfaces of the plurality of curved elongated microstructures has a surface area in a range from about 5% to about 45% of a planar surface area of the substrate's exterior surface, wherein the planar surface area is a summation of the surface area of the flat upper surfaces and the recessed area.

18. The fingerprint resistant substrate of claim 1, wherein the exterior surface of the substrate has a surface energy in a range from about 25 dynes/cm² to about 35 dynes/cm².

19. The fingerprint resistant substrate of claim 8, wherein the exterior surface of the substrate has a surface energy in a range from about 25 dynes/cm² to about 35 dynes/cm².

20. The fingerprint resistant substrate of claim 1, wherein each of the plurality of curved elongated microstructures has an orientation that is substantially random.

21. The fingerprint resistant substrate of claim 1, wherein the plurality of curved elongated microstructures has a distribution that is substantially random.

22. The fingerprint resistant substrate of claim 15, wherein each of the plurality of curved elongated microstructures has an orientation that is substantially random.

23. The fingerprint resistant substrate of claim 22, wherein the plurality of curved elongated microstructures has a distribution that is substantially random.

24. The fingerprint resistant substrate of claim 1, wherein the substrate comprises transparent glass or polymer.

25. The fingerprint resistant substrate of claim 1, wherein the substrate comprises a nontransparent material.

26. The fingerprint resistant substrate of claim 23, wherein the substrate is a polymeric film adapted to be disposed onto an outer surface of an optical display.

27. The fingerprint resistant substrate of claim 1, wherein the recessed area is a single continuous recessed area configured to permit the fluid migration throughout the entire recessed area.

28. The fingerprint resistant substrate of claim 8, wherein the recessed area is a single continuous recessed area configured to permit the fluid migration throughout the entire recessed area.

29. A fingerprint resistant system, comprising:
an optical display; and
a fingerprint resistant film disposed on an outer surface of the optical display substrate, wherein the film comprises a plurality of curved elongated microstructures and an interstitial area between adjacent microstructures of said plurality of curved elongated microstructures formed in an exterior surface of the film, wherein each of the plurality of microstructures has a flat upper surface and vertical or near vertical sidewalls, wherein the interstitial area between adjacent microstructures is a flat recessed area configured to permit fluid migration throughout the recessed area.

30. The fingerprint resistant substrate of claim 29, wherein each of the plurality of curved elongated microstructures has an orientation that is substantially random.

31. The fingerprint resistant substrate of claim 30, wherein the plurality of curved elongated microstructures has a distribution that is sufficiently substantially random such that Moiré is not detectable by a human eye.

32. The fingerprint resistant substrate of claim 31, wherein the flat recessed area is a single continuous flat recessed area configured to permit the fluid migration throughout the entire recessed area.

33. A fingerprint resistant substrate comprising a plurality of curved elongated microstructures and an interstitial area between adjacent microstructures of said plurality of curved elongated microstructures formed in an exterior surface of the substrate, wherein each of the plurality of microstructures has a flat recessed surface and vertical or near vertical sidewalls, wherein the interstitial area between adjacent microstructures is a raised area that extends over the entire exterior surface of the substrate.

34. The fingerprint resistant substrate of claim 33, wherein each of the plurality of curved elongated microstructures has an orientation that is substantially random.

35. The fingerprint resistant substrate of claim 34, wherein the plurality of curved elongated microstructures has a distribution that is substantially random.

36. The fingerprint resistant substrate of claim 33, wherein the raised area is a single continuous raised area.

37. A fingerprint resistant system, comprising:
an optical display; and
a fingerprint resistant film disposed on an outer surface of the optical display substrate, wherein the film comprises a plurality of curved elongated microstructures and an interstitial area between adjacent microstructures of said plurality of curved elongated microstructures formed in an exterior surface of the film, wherein each of the plurality of microstructures has a flat recessed surface and vertical or near vertical sidewalls, wherein the interstitial area between adjacent microstructures is a raised area that extends over the entire exterior surface of the film.

38. The fingerprint resistant substrate of claim 37, wherein each of the plurality of curved elongated microstructures has an orientation that is substantially random.

39. The fingerprint resistant substrate of claim 38, wherein the plurality of curved elongated microstructures has a distribution that is sufficiently substantially random such that Moiré is not detectable by a human eye.

40. The fingerprint resistant substrate of claim 39, wherein the raised area is a single continuous raised area.
